(19) United States
(12) Patent Application Publication
(10) Pub. No.: US 2019/0150213 A1
(43) Pub. Date: May 16, 2019

(54) METHOD FOR MANAGING RADIO RESOURCES IN COMMUNICATION SYSTEM AND APPARATUS FOR THE SAME

(71) Applicant: ELECTRONICS AND TELECOMMUNICATIONS RESEARCH INSTITUTE, Daejeon (KR)

(72) Inventor: Jae Heung KIM, Daejeon (KR)

(21) Appl. No.: 16/167,670

(22) Filed: Oct. 23, 2018

(30) Foreign Application Priority Data
Nov. 13, 2017 (KR) 10-2017-0150621

(51) Int. Cl. H04W 76/15; H04L 12/24

(52) U.S. Cl. CPC H04W 76/15; H04W 88/08; H04L 41/08

(57) ABSTRACT

An operation method of a base station belonging to an access network includes performing a first connection establishment procedure with a linking node belonging to the Xhaul network; performing a second connection establishment procedure with a management node supporting a mobility function and belonging to the core network when the first connection establishment procedure between the base station and the linking node is completed; configuring integrated radio resources used commonly in the access network and the Xhaul network when the second connection establishment procedure between the base station and the management node is completed; and configuring a first allowable resource to be used for the access network within the integrated radio resources.

### CROSS-REFERENCE TO RELATED APPLICATION

This application claims priority to Korean Patent Application No. 10-2017-0150621, filed on Nov. 13, 2017 in the Korean Intellectual Property Office (KIPO), the entire content of which is hereby incorporated by reference.

### BACKGROUND

### 1. Technical Field

The present disclosure relates to a technique for supporting mobility in a communication system, and more particularly, to a technique for radio resource management in a communication system including an access network, an Xhaul network, and a core network.

### 2. Description of Related Art

A communication system (hereinafter, an ‘integrated communication system’) using a higher frequency band (e.g., a frequency band of 6 GHz, or higher) than a frequency band (e.g., a frequency band lower below 6 GHz) of a long term evolution (LTE) based communication system (or, a LTE-A based communication system) is being considered for processing of soaring, wireless data. The integrated communication system may comprise an access network, an Xhaul network, and a core network, and the Xhaul network may support communications between the access network and the core network.

The reception performance of a signal may deteriorate due to path loss of a radio wave and reflection of the radio wave in such the high frequency band (e.g., a frequency band of 6 GHz or higher), and a small base station supporting smaller cell coverage than that of a macro base station can be introduced into the integrated communication system in order to solve this problem. In the integrated communication system, the small base station may be connected to a core network using a wired backhaul link, in which case an initial investment cost, management cost, or the like of the integrated communication system may be increased.

Meanwhile, the integrated communication system may comprise the small base station performing all the functions of a communication protocol (e.g., a remote radio transmission and reception function, a baseband processing function), a plurality of transmission reception points (TRPs) performing the remote radio transmission and reception function among the functions of the communication protocol, a baseband unit (BBU) block performing the baseband processing function among the functions of the communication protocol, and the like. The TRP may be a remote radio head (RRH), a radio unit (RU), or the like. The BBU block may include at least one BBU or at least one digital unit (DU). The BBU block may be referred to as a ‘BBU pool’, a ‘centralized BBU’, or the like. One BBU block may be connected to a plurality of TRPs, and perform the baseband processing function on signals received from the plurality of TRPs and signals to be transmitted to the plurality of TRPs.

In the integrated communication system, the small base station may be connected to the core network using a wireless backhaul link (e.g., a wireless backhaul link constituting the Xhaul network), and the TRP may be connected to the BBU block using a wireless fronthaul link (e.g., a wireless fronthaul link constituting the Xhaul network). The investment and management costs of an integrated communication system comprised of wireless links (e.g., a wireless backhaul link, a wireless fronthaul link) may be lower than those of an integrated communication system comprised of wired links (e.g., a wired backhaul link, a wired fronthaul link). Also, when the integrated communication system is configured with wireless links, the efficiency of the integrated communication system can be enhanced.

Also, when a communication service is provided to a user by using the same radio resources in the access network and the Xhaul network of the integrated communication system, the investment and management costs of the integrated communication system can be reduced and the communication service can be efficiently provided. Therefore, techniques for managing radio resources are required to provide communication services using the same radio resources in the access network and the Xhaul network of the integrated communication system.

### SUMMARY

Accordingly, embodiments of the present disclosure provide a method and an apparatus for providing communication services by using the same radio resources in an access network and an Xhaul network.

In order to achieve the objective of the present disclosure, an operation method of a base station belonging to an access network, in a communication system composed of the access network, an Xhaul network, and a core network, may comprise performing a first connection establishment procedure with a linking node (or donor node) belonging to the Xhaul network; performing a second connection establishment procedure with a management node supporting a mobility function and belonging to the core network when the first connection establishment procedure is completed; configuring integrated radio resources used commonly in the access network and the Xhaul network when the second connection establishment procedure is completed; and configuring a first allowable resource to be used for the access network within the integrated radio resources, wherein the Xhaul network supports communications between the access network and the core network.

The integrated radio resources may be a frequency band commonly used in the access network and the Xhaul network.

The capability information of the base station may be transmitted in the first connection establishment procedure and the second connection establishment procedure.

The configuring integrated radio resources may be performed under a control of a node determined as a primary node among the base station, the linking node (or donor node), and the management node.

The first allowable resource may be configured to be orthogonal to a second allowable resource used for the Xhaul network.

The linking node (or donor node) may be a base station or an Xhaul distributed unit (XDU) performing a relay function.

The operation method may further comprise transmitting a synchronization signal and system information by using the first allowable resource.

The operation method may further comprise performing a third connection establishment procedure with a terminal belonging to a service area of the base station; and providing a communication service to the terminal using the first allowable resource when the third connection establishment procedure is completed.

The operation method may further comprise transmitting a triggering message requesting a change of the integrated radio resources when a predefined event occurs; and reconfiguring the integrated radio resources based on the triggering message.

The predefined event may include at least one of a case when a change rate (or variance rate) of the first allowable resource is equal to or greater than a threshold value, a case when an occupancy rate of the first allowable resource is equal to or greater than a threshold value, a case when a block error rate (BLER) is equal to or greater than a threshold value in communications based on the first allowable resource, a case when a latency time is equal to or larger than a threshold value in communications based on the first allowable resource, and a case when a transmission buffer residence time is equal to or greater than a threshold value in communications based on the first allowable resource.

The operation method may further comprise transmitting a release message requesting release of the integrated radio resources when a predefined event occurs; and releasing the integrated radio resources based on the release message.

The predefined event may include at least one of a case when the base station terminates provision of a communication service based on the integrated radio resources, a case when an operation state of the base station transitions from an active state to an inactive state, and a case when a management function of the integrated radio resources in each of the base station, the linking node (or donor node), and the management node is suspended.

In order to achieve the objective of the present disclosure, a base station belonging to an access network, in a communication system composed of the access network, an Xhaul network, and a core network, may comprise a processor and a memory storing at least one instruction executed by the processor, wherein the at least one instruction is configured to perform a first connection establishment procedure with a linking node (or donor node) belonging to the Xhaul network; perform a second connection establishment procedure with a management node supporting a mobility function and belonging to the core network when the first connection establishment procedure is completed; configure integrated radio resources used commonly in the access network and the Xhaul network when the second connection establishment procedure is completed; and configure a first allowable resource to be used for the access network within the integrated radio resources, wherein the Xhaul network supports communications between the access network and the core network.

The integrated radio resources may be a frequency band commonly used in the access network and the Xhaul network.

The integrated radio resources may be configured under a control of a node determined as a primary node among the base station, the linking node (or donor node), and the management node.

The at least one instruction may be further configured to transmit a synchronization signal and system information by using the first allowable resource.

The at least one instruction may be further configured to perform a third connection establishment procedure with a terminal belonging to a service area of the base station; and provide a communication service to the terminal using the first allowable resource when the third connection establishment procedure is completed.

The at least one instruction may be further configured to transmit a triggering message requesting a change of the integrated radio resources when a predefined event occurs; and reconfigure the integrated radio resources based on the triggering message.

The predefined event may include at least one of a case when a change rate (or variance rate) of the first allowable resource is equal to or greater than a threshold value, a case when an occupancy rate of the first allowable resource is equal to or greater than a threshold value, a case when a block error rate (BLER) is equal to or greater than a threshold value in communications based on the first allowable resource, a case when a latency time is equal to or larger than a threshold value in communications based on the first allowable resource, and a case when a transmission buffer residence time is equal to or greater than a threshold value in communications based on the first allowable resource.

The at least one instruction may be further configured to transmit a release message requesting release of the integrated radio resources when a predefined event occurs; and release the integrated radio resources based on the release message.

According to the embodiments of the present disclosure, the integrated communication system comprises an access network, an Xhaul network and a core network, and the access network and the Xhaul network can provide communication services to a user by using the same radio resources. Further, the same radio resources may be reconfigured when a predefined event occurs, and the communication services can be provided to the user through the access network and the Xhaul network by using the same radio resources that have been reconfigured. Therefore, the radio resources can be efficiently used in the integrated communication system, and the performance of the integrated communication system can be improved.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating a first embodiment of a communication system;

FIG. 2 is a block diagram illustrating a first embodiment of a communication node constituting a communication system;

FIG. 3 is a conceptual diagram illustrating a second embodiment of a communication system;

FIG. 4 is a conceptual diagram illustrating a first embodiment of an integrated communication system;

FIG. 5 is a conceptual diagram illustrating a second embodiment of an integrated communication system;

FIG. 6 is a conceptual diagram illustrating a third embodiment of an integrated communication system;

FIG. 7 is a conceptual diagram illustrating a first embodiment of radio resources configured for an access network and an Xhaul network;

FIG. 8 is a conceptual diagram illustrating a first embodiment of a method of transmitting synchronization signals and system information in an integrated communication system;

FIG. 9 is a conceptual diagram illustrating a second embodiment of a method of transmitting synchronization signals and system information in an integrated communication system;

FIG. 10 is a conceptual diagram illustrating a third embodiment of a method of transmitting synchronization signals and system information in an integrated communication system;

FIG. 11 is a conceptual diagram illustrating a fourth embodiment of a method of transmitting synchronization signals and system information in an integrated communication system;

FIG. 12 is a conceptual diagram illustrating a fifth embodiment of a method of transmitting synchronization signals and system information in an integrated communication system;

FIG. 13 is a conceptual diagram illustrating a sixth embodiment of a method of transmitting synchronization signals and system information in an integrated communication system;

FIG. 14 is a conceptual diagram illustrating a first embodiment of an SS/PBCH transmission method in an integrated radio resource management based on a time division duplex (TDD) scheme;

FIG. 15 is a conceptual diagram illustrating a second embodiment of an SS/PBCH transmission method in an integrated radio resource management based on a TDD scheme;

FIG. 16 is a sequence chart illustrating a first embodiment of a signaling procedure for variably managing integrated radio resources; and

FIG. 17 is a sequence chart illustrating a second embodiment of a signaling procedure for variably managing integrated radio resources.

### DETAILED DESCRIPTION

While the present invention is susceptible to various modifications and alternative forms, specific embodiments are shown by way of example in the drawings and described in detail. It should be understood, however, that the description is not intended to limit the present invention to the specific embodiments, but, on the contrary, the present invention is to cover all modifications, equivalents, and alternatives that fall within the spirit and scope of the present invention.

Although the terms “first,” “second,” etc. may be used herein in reference to various elements, such elements should not be construed as limited by these terms. These terms are only used to distinguish one element from another. For example, a first element could be termed a second element, and a second element could be termed a first element, without departing from the scope of the present invention. The term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directed coupled” to another element, there are no intervening elements.

The terminology used herein is for the purpose of describing particular embodiments only and is not intended to be limiting of embodiments of the present invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, parts, and/or combinations thereof, but do not preclude the presence or addition of one or more other features, integers, steps, operations, elements, parts, and/or combinations thereof.

Unless otherwise defined, all terms (including technical and scientific terms) used herein have the same meaning as commonly understood by those of ordinary skill in the art to which the present invention pertains. It will be further understood that terms defined in commonly used dictionaries should be interpreted as having a meaning that is consistent with their meaning in the context of the related art and will not be interpreted in an idealized or overly formal sense unless expressly so defined herein.

Hereinafter, exemplary embodiments of the present invention will be described in greater detail with reference to the accompanying drawings. To facilitate overall understanding of the present invention, like numbers refer to like elements throughout the description of the drawings, and description of the same component will not be reiterated.

Hereinafter, a communication system to which embodiments according to the present disclosure will be described. However, the communication systems to which embodiments according to the present disclosure are applied are not restricted to what will be described below. That is, the embodiments according to the present disclosure may be applied to various communication systems. Here, the term ‘communication system’ may be used with the same meaning as the term ‘communication network’.

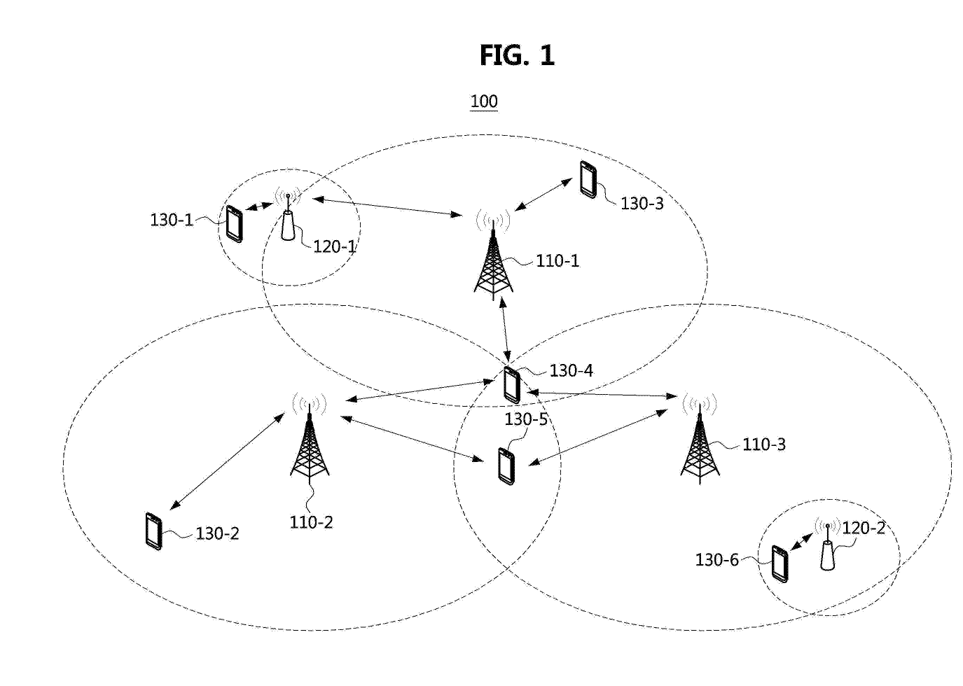

FIG. 1 is a conceptual diagram illustrating a first embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further include a core network. The core network supporting 4G communication (e.g., long term evolution (LTE) and LTE-advanced (LTE-A)) may comprise a serving gateway (S-GW), a packet data network (PDN) gateway (P-GW), a mobility management entity (MME), and the like. The core network supporting 5G communication (e.g., new radio (NR)) may comprise a user plane function (UPF), an access and mobility management function (AMF), and the like. The S-GW may correspond to the UPF, and the MME may correspond to the AMF. Thus, in the embodiments described below, the S-GW may mean the UPF, the MME may mean the AMF, and the S-GW/MME may mean the UPF/AMF.

The plurality of communication nodes may support 4th generation (4G) communication (e.g., long term evolution (LTE), LTE-advanced (LTE-A)), 5th generation (5G) communication, or the like. The 4G communication may be performed in a frequency band below 6 gigahertz (GHz), and the 5G communication may be performed in a frequency band above 6 GHz. For example, for the 4G and 5G communications, the plurality of communication nodes may support at least one communication protocol among a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a cyclic prefix OFDM (CP-OFDM) based communication protocol, a discrete Fourier transform spread OFDM (DFT-s-OFDM) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, and a space division multiple access (SDMA) based communication protocol. Each of the plurality of communication nodes may have the following structure.

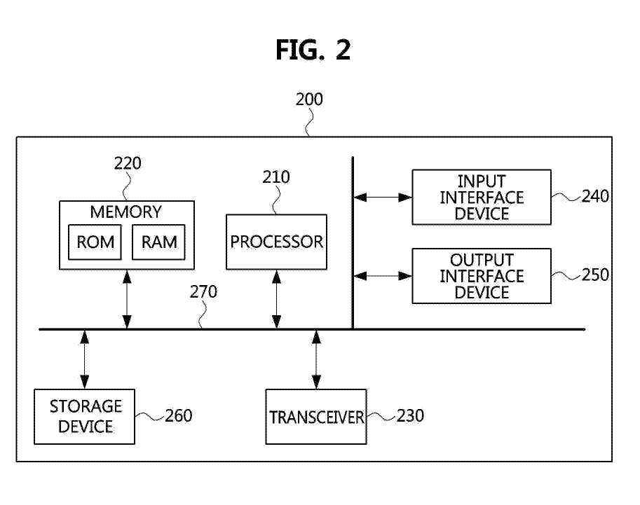

FIG. 2 is a block diagram illustrating a first embodiment of a communication node constituting a cellular communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a gNB, an ng-eNB, a base transceiver station (BTS), a radio base station, a radio transceiver, an access point, an access node, a road side unit (RSU), a radio remote head (RRH), a transmission point (TP), a transmission and reception point (TRP), a flexible TRP (f-TRP), or the like. Also, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, a device supporting internet of things (IoT) functions, a mounted module/device/terminal, an on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Also, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communications (or, proximity services (Prose)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, in a communication system, a base station may perform all functions (e.g., remote radio transmission and reception function, baseband processing function, and the like) according to a communication protocol. Alternatively, the remote radio transmission and reception function among all the functions according to the communication protocol may be performed by a transmission reception point (TRP) (e.g., f-TRP), and the baseband processing function among all the functions according to the communication protocol may be performed by a baseband unit (BBU) block. The TRP may be a remote radio head (RRH), a radio unit (RU), a transmission point (TP), or the like. The BBU block may include at least one BBU or at least one digital unit (DU). The BBU block may be referred to as a ‘BBU pool’, a ‘centralized BBU’, or the like. The TRP may be connected to the BBU block via a wired fronthaul link or a wireless fronthaul link. A communication system composed of a backhaul link and a fronthaul link may be as follows. When a function-split technique of the communication protocol is applied, the TRP may selectively perform some functions of the BBU or some functions of a medium access control (MAC) or a radio link control (RLC) layer.

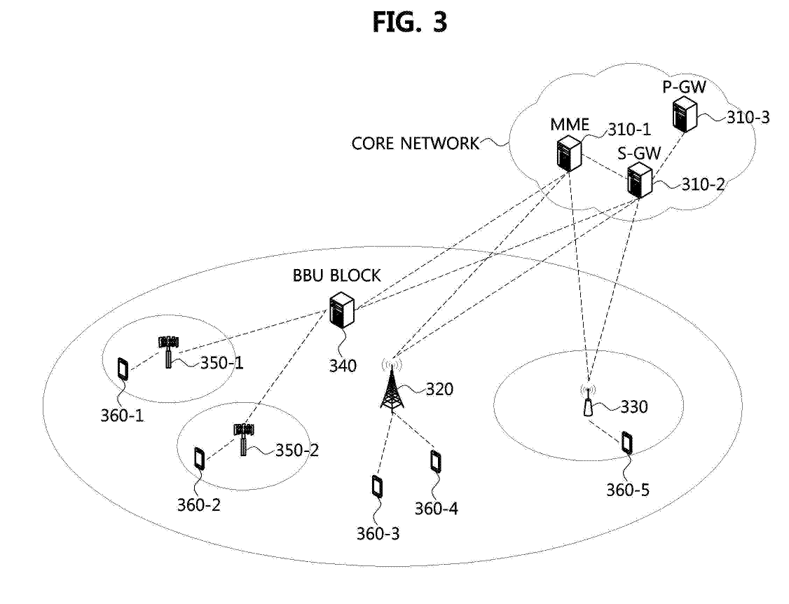

FIG. 3 is a conceptual diagram illustrating a second embodiment of a communication system.

Referring to FIG. 3, a communication system may include a core network and an access network. The core network supporting the 4G communications may include an MME 310-1, an S-GW 310-2, a P-GW 310-3, and the like. The core network supporting the 5G communications may include AMF, UPF, or the like. The access network may include a macro base station 320, a small base station 330, TRPs 350-1 and 350-2, terminals 360-1, 360-2, 360-3, 360-4, and 360-5, and the like. The macro base station 320 or the small base station 330 may be connected with an end node of the core network via a wired backhaul. The TRPs 350-1 and 350-2 may support the remote radio transmission and reception function among all the functions according to the communication protocol, and the baseband processing functions for the TRPs 350-1 and 350-2 may be performed by the BBU block 340. The BBU block 340 may belong to the access network or the core network. The communication nodes (e.g., MME, S-GW, P-GW, AMF, UPF, macro base station, small base station, TRPs, terminals, and BBU block) belonging to the communication system may be configured identically or similarly to the communication node 200 shown in FIG. 2.

The macro base station 320 may be connected to the core network (e.g., MME 310-1, S-GW 310-2, AMF, UPF, or the like) using a wired backhaul link or a wireless backhaul link, and provide communication services to the terminals 360-3 and 360-4 based on a communication protocol (e.g., 4G communication protocol, 5G communication protocol). The small base station 330 may be connected to the core network (e.g., MME 310-1, S-GW 310-2, AMF, UPF, or the like) using a wired backhaul link or a wireless backhaul link, and may provide communication services to the terminal 360-5 based on a communication protocol (e.g., 4G communication protocol, 5G communication protocol).

The BBU block 340 may be located in the MME 310-1, the S-GW 310-2, AMF, UPF, or the macro base station 320. Alternatively, the BBU block 340 may be located independently of each the MME 310-1, the S-GW 310-2, AMF, UPF, and the macro base station 320. For example, the BBU block 340 may be configured as a logical function between the macro base station 320 and the MME 310-1 (or S-GW 310-2). The BBU block 340 may support the plurality of TRPs 350-1 and 350-2, and may be connected to each of the plurality of TRPs 350-1 and 350-2 using a wired fronthaul link or a wireless fronthaul link. That is, the link between the BBU block 340 and the TRPs 350-1 and 350-2 may be referred to as a ‘fronthaul link’.

The first TRP 350-1 may be connected to the BBU block 340 via a wired fronthaul link or a wireless fronthaul link, and provide communication services to the first terminal 360-1 based on a communication protocol (e.g., 4G communication protocol, 5G communication protocol). The second TRP 350-2 may be connected to the BBU block 340 via a wired fronthaul link or a wireless fronthaul link, and provide communication services to the second terminal 360-2 based on a communication protocol (e.g., 4G communication protocol, 5G communication protocol).

In the embodiments to be described below, a communication system including an access network, an Xhaul network, and a core network may be referred to as an ‘integrated communication system’. The communication nodes (e.g., MME, S-GW, P-GW, AMF, UPF, BBU block, Xhaul distributed unit (XDU), Xhaul control unit (XCU), base station, TRP, terminal, and the like) may be configured identically or similarly to the communication node 200 shown in FIG. 2. The communication nodes belonging to the Xhaul network may be connected using an Xhaul link, and the Xhaul link may be a backhaul link or a fronthaul link.

Also, the S-GW (or, UPF) of the integrated communication system may refer to an end communication node of the core network that exchanges packets (e.g., control information, data) with the base station, and the MME (or, AMF) of the integrated communication system may refer to a communication node in the core network that performs control functions for a wireless access section (or, interface) of the terminal. Here, each of the backhaul link, the fronthaul link, the Xhaul link, the XDU, the XCU, the BBU block, the S-GW, the MME, the AMF, and the UPF may be referred to as a different term according to a function (e.g., function of the Xhaul network, function of the core network) of a communication protocol depending on a radio access technology (RAT).

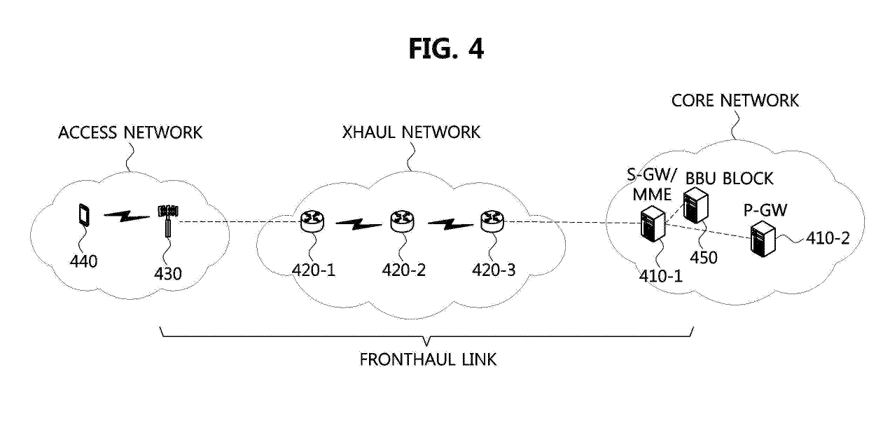

FIG. 4 is a conceptual diagram illustrating a first embodiment of an integrated communication system.

Referring to FIG. 4, the integrated communications system may include an access network, an Xhaul network, and a core network. The Xhaul network may be located between the access network and the core network, and may support communications between the access network and the core network. The communication nodes belonging to the integrated communication system may be configured to be the same as or similar to the communication node 200 shown in FIG. 2. The access network may include a TRP 430, a terminal 440, and the like. The Xhaul network may include a plurality of communication nodes 420-1, 420-2, and 420-3. The communication node constituting the Xhaul network may be referred to as an ‘XDU’. In the Xhaul network, the XDUs 420-1, 420-2, and 420-3 may be connected using wireless Xhaul links and may be connected based on a multi-hop scheme. The core network may include an S-GW/MME 410-1 (or, UPF/AMF), a P-GW 410-2, and the like. The S-GW/MME 410-1 may refer to a communication node including an S-GW and an MME, and the UPF/AMF may refer to a communication node an UPF and an AMF. The BBU block 450 may be located in the S-GW/MME 410-1 and may be connected to the third XDU 420-3 via a wired link.

The first XDU 420-1 of the Xhaul network may be connected to the TRP 430 using a wired link. Alternatively, the first XDU 420-1 may be integrated into the TRP 430. The second XDU 420-2 may be connected to each of the first XDU 420-1 and the third XDU 420-3 using a wireless link (e.g., wireless Xhaul link), and the third XDU 420-3 may be connected to an end communication node (e.g., the S-GW/MME 410-1) of the core network using a wired link. Among the plurality of XDUs 420-1, 420-2, and 420-3 of the Xhaul network, an XDU connected to an end communication node of the core network may be referred to as an ‘XDU aggregator’. That is, the third XDU 420-3 in the Xhaul network may be the XDU aggregator. The functions of the XDU aggregator may be performed by the S-GW/MME 410-1 in the core network.

The communications between the plurality of XDUs 420-1, 420-2 and 420-3 may be performed using a communication protocol for the Xhaul link (hereinafter, ‘Xhaul protocol’), which is different from an access protocol (e.g., a communication protocol used for communications between the terminal 440 and the TRP 430 (or, macro base station, small base station)). Packets to which the Xhaul protocol is applied may be transmitted to each of the core network and the access network through the Xhaul link. Here, the packets may indicate control information, data, and the like.

The TRP 430 may provide communication services to the terminal 440 using an access protocol (e.g., 4G communication protocol, 5G communication protocol), and may be connected to the first XDU 420-1 using a wired link. The TRP 430 may support a remote radio transmission and reception function among all the functions according to the communication protocol, and the baseband processing function for the TRP 430 may be performed in the BBU block 450. A link (e.g., “TRP 430-first XDU 420-1-second XDU 420-2-third XDU 420-3-BBU block 450 (or, SGW/MME 410-1)”) between the TRP 430 performing the remote radio transmission and reception function and the BBU block 450 performing the baseband processing function may be referred to as a ‘fronthaul link’. For example, the fronthaul link may be configured differently depending on the location of the BBU block 450 performing the baseband processing function.

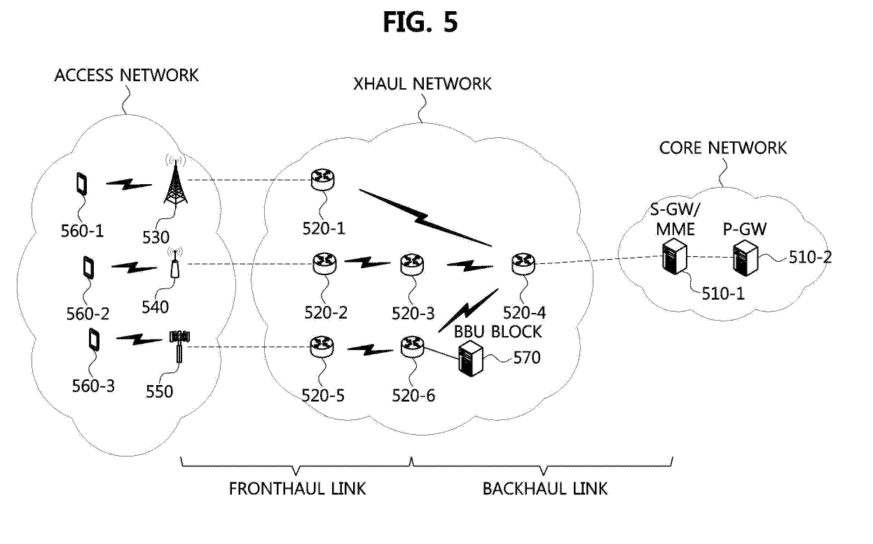

FIG. 5 is a conceptual diagram illustrating a second embodiment of an integrated communication system.

Referring to FIG. 5, the integrated communications system may include an access network, an Xhaul network, and a core network. The Xhaul network may be located between the access network and the core network, and may support communications between the access network and the core network. The communication nodes belonging to the integrated communication system may be configured to be the same as or similar to the communication node 200 shown in FIG. 2. The access network may include a macro base station 530, a small base station 540, a TRP 550, terminals 560-1, 560-2, and 560-3, and the like. The Xhaul network may include a plurality of communication nodes 520-1, 520-2, 520-3, 520-4, 520-5, and 520-6. The communication node constituting the Xhaul network may be referred to as an ‘XDU’. In the Xhaul network, the XDUs 520-1, 520-2, 520-3, 520-4, 520-5, and 520-6 may be connected using wireless Xhaul links and may be connected based on a multi-hop scheme. A BBU block 570 may be located in one XDU among the plurality of XDUs 520-1, 520-2, 520-3, 520-4, 520-5, and 520-6. For example, the BBU block 570 may be located in the sixth XDU 520-6. The core network may include an S-GW/MME 510-1 (or, UPF/AMF), a P-GW 510-2, and the like. The S-GW/MME 510-1 may refer to a communication node including an S-GW and an MME. The S-GW/MME 410-1 may refer to a communication node including an S-GW and an MME, and the UPF/AMF may refer to a communication node an UPF and an AMF.

The first XDU 520-1 of the Xhaul network may be connected to the macro base station 530 using a wired link, or may be integrated into the macro base station 530. The second XDU 520-2 of the Xhaul network may be connected to the small base station 540 using a wired link, or may be integrated into the small base station 540. The fifth XDU 520-5 of the Xhaul network may be connected to the TRP 550 using a wired link, or may be integrated into the TRP 550.

The fourth XDU 520-4 may be connected to an end communication node (e.g., the S-GW/MME 510-1) of the core network using a wired link. Among the plurality of XDUs 520-1, 520-2, 520-3, 520-4, 520-5, and 520-6, an XDU connected to an end communication node of the core network may be referred to as an ‘XDU aggregator’. That is, the fourth XDU 520-4 may be the XDU aggregator. The communications between the plurality of XDUs 520-1, 520-2, 520-3, 520-4, 520-5, and 520-6 may be performed using the Xhaul protocol. Packets (e.g., data, control information) to which the Xhaul protocol is applied may be transmitted to each of the core network and the access network via the Xhaul link.

The macro base station 530 may provide communication services to the first terminal 560-1 using an access protocol (e.g., 4G communication protocol, 5G communication protocol), and may be connected to the first XDU 520-1 via a wired link. The macro base station 530 may be connected to the core network via the Xhaul network, and a link of “macro base station 530-first XDU 520-1-fourth XDU 520-4-S-GW/MME 510-1” may be referred to as a ‘backhaul link’. The small base station 540 may provide communication services to the second terminal 560-2 using an access protocol (e.g., 4G communication protocol, 5G communication protocol), and may be connected to the second XDU 520-2 using a wired link. The small base station 540 may be connected to the core network via the Xhaul network, and a link of “small base station 540-second XDU 520-2-third XDU 520-3-fourth XDU 520-4-S-GW/MME 510-1” may be referred to as a ‘backhaul link’.

The TRP 550 may provide communication services to the third terminal 560-3 using an access protocol (e.g., 4G communication protocol, 5G communication protocol), and may be connected to the fifth XDU 520-5 using a wired link. The TRP 550 may support a remote radio transmission and reception function among all the functions according to the communication protocol, and the baseband processing function for the TRP 550 may be performed in the BBU block 570. A link (e.g., a link of “TRP 550-fifth XDU 520-5-BBU block 570 (or, sixth XDU 520-6)”) between the TRP 550 performing the remote radio transmission and reception function and the BBU block 570 performing the baseband processing function may be referred to as a ‘fronthaul link’, and a link (e.g., a link of “BBU block 570 (or, sixth XDU 520-6) fourth XDU 520-4-S-GW/MME 510-1”) between the BBU block 570 and the S-GW/MME 510-1 may be referred to as a ‘backhaul link’. For example, the fronthaul link may be configured differently depending on the location of the BBU block 570 performing the baseband processing function.

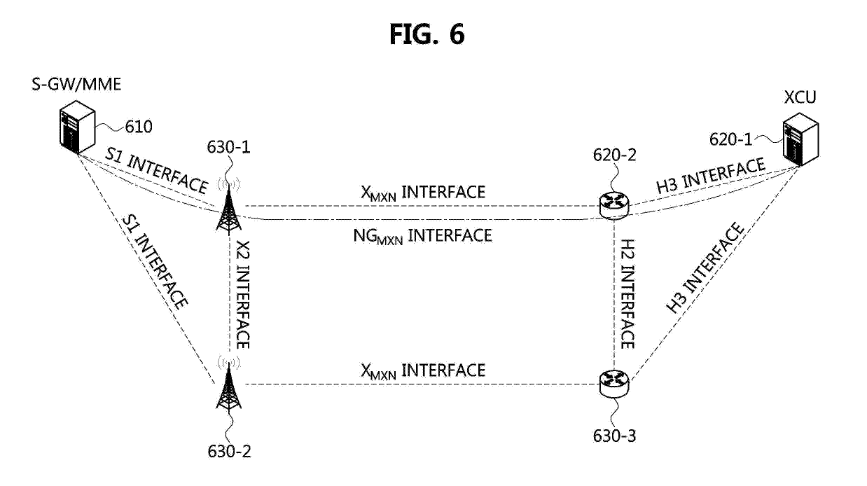

FIG. 6 is a conceptual diagram illustrating a third embodiment of an integrated communication system.

Referring to FIG. 6, an integrated communications system may comprise an access network, an Xhaul network, and a core network. The communications between the XCU 620-1 and the XDUs 620-2 and 620-3 may be performed through H3 interfaces, and the communications between the XDUs 620-2 and 620-3 may be performed through a H2 interface. The communications between the XDUs 620-2 and 620-3 and the base stations 630-1 and 630-2 may be performed through X_{MXN} interfaces and the communications between the base stations 630-1 and 630-2 may be performed an X2 interface (or, Xn interface). Each of the base stations 630-1 and 630-2 may be an eNB, a gNB, and an ng-eNB. The eNB may indicate the base station supporting the 4G communication protocol, and the gNB or the ng-eNB may indicate the base station supporting the 5G communication protocol.

The communications between the S-GW/MME 610 and the XCU 620-1 may be performed a next generation (NG)_{MXN} interface, and the communications between the S-GW/MME 610 and the base stations 630-1 and 630-2 may be performed through S1 interfaces (or, NG interfaces). The S-GW/MME 610 may be referred to as UPF/AMF, and the UPF/AMF may refer to a communication node including the UPF and the AMF. The UPF may perform functions for connection with a user plane of the access network by performing functions of a termination communication node of the core network. For example, the UPF may perform functions corresponding to the S-GW. The AMF may perform functions for connection with a control plane of the access network by performing functions of a termination communication node of the core network. The AMF may perform a connection management function, a mobility management function, and the like for the terminal. For example, the AMF may perform functions corresponding to the MME. In the integrated communication system, the S-GW may be referred to as another term instead of the UPF, and the MME may be referred to as another term instead of the AMF.

Hereinafter, radio resource management methods in the integrated communication system will be described. Even when a method (e.g., transmission or reception of a signal) to be performed at a first communication node among the communication nodes is described, a corresponding second communication node may perform a method (e.g., reception or transmission of the signal) corresponding to the method performed at the first communication node. That is, when an operation of the terminal is described, the corresponding base station may perform an operation corresponding to the operation of the terminal. Conversely, when an operation of the base station is described, the corresponding terminal may perform an operation corresponding to the operation of the base station. The radio resource management methods may be applied to the access network and the Xhaul network. Also, the radio resource management methods may be applied to a network configured without XDU and XCU (e.g., a network including a terminal, a base station, a BBU block, an MME (or AMF), an S-GW (or UPF), and the like).

The communication node (e.g., XCU or XDU) may perform the following functions for the radio resource management in the integrated communication system. The XCU may perform an admission control function, a load control function, and the like.
Admission control function
Activation of an XDU sector
Establishment (or setup), configuration, modification, addition, or release of an Xhaul link radio bearer (XL-RB)
Load control function for each Xhaul link (XL) in the Xhaul network
Determination on Whether to increase or decrease radio resources for an XL (e.g., the determination function may be performed in units of the XDU)

The XDU may generate a control message that triggers (e.g., requests) increase or decrease of radio resources allocated or occupied among XDUs (or, XDU sectors), and transmit the generated control message to the XCU (or, peer XDU or peer XDU sector). The XDU may be classified into a master XDU and a slave XDU, and the XDU sector may be classified into a master XDU sector and a slave XDU sector. The functions of the master XDU, the master XDU sector, the slave XDU, and the skive XDU sectors may be as follows.
Master XDU (or, master XDU sector)
Allocation of radio resources in units of transmission time intervals (TTIs) consideration of quality of service (QoS)
Ensuring fairness between XL-RBs having the same QoS
Slave XDU (or, slave XDU sector)
Measurement or reporting of radio channel status and buffer status
XCU priority handling function for transmission XL-RBs of the slave XDU (or, slave XDU sector)

The master XDU (or, master XDU sector) may acquire quality information (e.g., a channel quality indicator (CQI), a channel status indicator (CSI), or the like) of the radio channel measured by the slave XDU (or, slave XDU sector), and perform a scheduling function (e.g., a radio resource allocation function, a modulation and coding scheme (MCS) level setting function, or the like) on the radio resources (e.g., transmission radio resources of the master XDU (or, master XDU sector), transmission radio resources of the slave XDU (or, slave XDU sector), or the like).

The admission control function supported by the XCU may be performed for activation of an XDU sector, configuration of a new XL-RB, modification, addition, or release of an XL-RB, and the like. The XL-RB may be modified based on the buffer status, the load status, and the like, and the configuration condition of the radio resources that has been configured may be modified for changing the XL-RB. An addition procedure of XL-RB may be performed to newly create an XL-RB having a QoS different from the QoS of the preconfigured XL-RB. An establishment (or setup) procedure of XL-RB with a new QoS may be triggered by an XL node or an access link (AL) node. The XL node may refer to a communication node (e.g., XCU, XDU, XDU sector, etc.) included in the Xhaul network, and the AL node may refer to a communication node (e.g., base station, eNB, gNB, ng-eNB, TRP, f-TRP, cell, RRH, etc.) included in the access network. A release procedure of XL-RB may be performed to release some XL-RBs among the existing XL-RBs. When all the XL-RBs of the corresponding XDU sector are released, the corresponding XDU sector may operate in an idle state.

The XCU may perform the admission control function in consideration of the AL nodes interworking with the XDUs of the Xhaul network, and may perform signaling procedures necessary for the admission control function with the AL nodes by using the NG_{MXN} interface and the X_{MXN} interface (e.g., the NG_{MXN} interface and the X_{MXN} interface illustrated in FIG. 6). The NG_{MXN} interface may be the interface between the MME (e.g., AMF) and the XCU, and may be used to exchange signaling messages via a physical interface between the base station (e.g., eNB, gNB, or ng-eNB) and the XDU. The signaling message (e.g., a signaling message for the X_{MXN} interface (hereinafter referred to as ‘X_{MXN} signaling message’) generated by the base station (e.g., eNB, gNB, or ng-eNB) among the AL nodes may be defined based on a message for the X2 interface (or Xn interface) in the 3GPP-based communication system (e.g., LTE communication system or new radio (NR) communication system).

Also, a signaling message (e.g., a signaling message for the NG_{MXN} interface (hereinafter referred to as ‘NG_{MXN} signaling message’) generated by the MME (e.g., AMF, hereinafter referred to as ‘AL network node’) among the AL nodes may be defined based on a message for the S1 interface (or, NG interface) in the 3GPP-based communication system (e.g., LTE communication system or NR communication system).

An information element (IE), a parameter, etc. necessary for the NG_{MXN} signaling message or the X_{MXN} signaling message may be further defined. The X_{MXN} signaling message generated and transmitted by the AL access node may include a NodeB (NB) status transfer message, an NB configuration transfer message, an NB configuration update message, a resource status request message, a resource status update message, or the like. The NG_{MXN} signaling message generated and transmitted by the AL network node may include an MME status transfer message, an MME configuration transfer message, or the like.
NB status transfer message
The NB status transfer message may be used for transferring status information of the AL node, and may include a flow identifier, a mapping relation between the flow identifier and a data bearer, a PDCP sequence number (SN), a hyper frame number (HFN), or the like.
NB configuration transfer message
The NB configuration transfer message may be used for transferring configuration information of the AL node, and may include an identifier of the AL node, a transmission frequency, a system bandwidth, antenna configuration information, beam configuration information according to a beamforming technique, configuration information of integrated radio resources (e.g., radio resources used commonly by the access network and the Xhaul network), or the like.
NB configuration update message
The NB configuration update message may be used for transferring updated configuration information of the AL node, and may include an identifier of the AL node, a transmission frequency, a system bandwidth, configuration information of physical layer resources (e.g., channel), antenna configuration information, beam configuration information according to a beamforming technique, configuration information of integrated radio resources, or the like.
The configuration information of physical layer resources may include radio resource regions and parameters configured for a random access procedure, a system information transmission procedure, multimedia broadcast multicast service single frequency network (MBSFN) subframes, a procedure for indicating activation or inactivation of a node, a beam sweeping procedure according to a beamforming technique, or the like.
The antenna configuration information and the beam configuration information according to a beamforming technique may include antenna ports, a beam width, a beam transmission and reception angle (e.g., bean transmission and reception direction), a beam transmission pattern, a beam transmission region (e.g., subcarrier index, transmission time index, offset, etc.), or the like.
The configuration information of integrated radio resources may include configuration information of allowable resources, a reference parameter for triggering a change of the allowable resources, a value of the reference parameter (e.g., range), or the like.
Resource status request message
The resource status request message may be used for requesting a report of status information of radio resources. Also, the resource status request message may be used for transferring information for triggering a change of the allowable resources.
Resource status update message
The resource status update message may be used for transferring updated status information of radio resources, and may include radio resource allocation information of a node (e.g., XL node, AL node, etc.), an identifier of a peer node (e.g., peer XL node, peer AL node, terminal, etc.) to which a service is being provided, a measurement result for a peer node or an adjacent node, configuration information of allowable resources, a reference parameter for triggering a change of the allowable resources, a value of the reference parameter (e.g., range), or the like.
The measurement result for a peer node or an adjacent node may include a reference signal received power (RSRP), a reference signal received quality (RSRQ), a CQI, a CSI, a beam sweeping measurement result, a measurement result for a serving beam or an adjacent beam, an interference measurement result, or the like.
MME status transfer message
The MME status transfer message may be used for transferring status information of the MME, and may include a PDCP SN, a HFN, or the like.
MME configuration transfer message
The MME configuration transfer message may be used for transferring configuration information of a radio access network (RAN), and may include configuration information of a self-optimizing network (SON), transport network layer (TNL) information of the interfaces (e.g., X2 interface, Xn interface, NG_{MXN} interface, X_{MXN} interface, etc.), address information of a transport layer, information on a general packet radio service (GPRS) tunneling protocol (GTP) transport layer, encryption information, authentication information, information of an adjacent AL node (e.g., identifier of an adjacent node), or the like.

Meanwhile, the NG_{MXN} signaling message generated and transmitted by the XCU among the XL nodes may include an XCU status transfer message, an XCU configuration transfer message, or the like. The X_{MXN} signaling message generated and transmitted by the XDU among the XL nodes may include an XDU status transfer message, an XDU configuration transfer message, an XDU configuration update message, a resource status report message, a resource status update message, or the like.
XDU status transfer message
The XDU status transfer message may be used for transferring status information of the XL node, and may include a flow identifier, a PDCP SN, or the like.
XDU configuration transfer message
The XDU configuration transfer message may be used for transferring configuration information of the XL node, and may include an identifier of the XL node, a transmission frequency, a system bandwidth, antenna configuration information, beam configuration information according to a beamforming technique, configuration information of integrated radio resources, or the like.
XDU configuration update message
The XDU configuration update message may be used for transferring updated configuration information of the XL node, and may include an identifier of the XL node, a transmission frequency, a system bandwidth, configuration information of physical layer resources (e.g., channel), antenna configuration information, beam configuration information according to a beamforming technique, configuration information of allowable resources, a reference parameter for triggering a change of the allowable resources, a value (e.g., range) of the reference parameter, information of the XL node, resource allocation readjustment information, or the like.
Resource status report message
The resource status report message may be used for reporting resource status of the XL node.
Resource status update message
The resource status update message may be used for transferring updated status information of radio resources, and may include radio resource allocation information of a node (e.g., XL node, AL node, etc.), an identifier of a peer node (e.g., peer XL node, peer AL node, terminal, etc.) to which a service is being provided, a measurement result for a peer node and an adjacent node, configuration information of allowable resources, a reference parameter for triggering a change of the allowable resources, a value (e.g., range) of the reference parameter, or the like.
The measurement result for a peer node or an adjacent node may include an RSRP, an RSRQ, a CQI, a CSI, a beam sweeping measurement result, a measurement result for a serving beam or an adjacent beam, an interference measurement result, or the like.
XCU status transfer message
The XCU status transfer message may be used for transferring status information of the XCU, and may include H3 signaling information, a flow identifier, a PDCP SN, a HFN, or the like.
XCU configuration transfer message
The XCU configuration transfer message may be used for transferring MXN configuration information, and may include TNL information of interfaces (e.g., H3 interface, NG_{MXN} interface, H2 interface, X_{MXN} interface, etc.), TLA information, encryption information, authentication information, information of an adjacent XL node, or the like.

Meanwhile, the XL-RB may be created based on a QoS, and may be created so as to distinguish a base station (e.g., gNB, ng-eNB, eNB, or f-TRP) interworking with the XDU sector. When the XL-RB is created and managed in units of a base station (e.g., gNB, ng-eNB, eNB, or f-TRP) based on the QoS, the radio resources of the XDU sector may be allocated so that the fairness between the XL-RBs of a plurality of base stations (e.g., gNB, ng-eNB, eNB, or f-TRP) having the same QoS can be ensured.

The master XDU sector may perform a scheduling (e.g., determination of an MCS level, allocation of radio resources (e.g., frequency resource, time resource, or beam), etc.) based on the QoS (e.g., QoS per XL-RB), buffer status report (BSR) of the slave XDU sector, the radio channel quality, or the like. The minimum resource for scheduling in units TTI may be a physical layer radio resource consisting of 12 subcarriers.

In consideration of the QoS of the XL-RB, the radio channel quality (e.g., RSRP, RSRQ, CQI, CSI, etc.), the size of a traffic message to be transmitted, and the like, a radio resource configured by a multiple of the minimum resource may be allocated according to a scheduling period (e.g., TTI). Table 1 below shows the number of data bits that can be allocated to a minimum PRB unit radio resource according to the number of symbols (e.g., 2 symbols, 7 symbols, 12 symbols, etc.) constituting the TTI when the radio resource is allocated based on the CQI or the CSI.

TABLE 1

| | 2 symbols for TTI | 7 symbols for TTI | 12 symbols for TTI |
|---|---|---|---|
| CQI 1 | 6 bits | 24 bits | 50 bits |
| CQI 2 | 6 bits | 24 bits | 50 bits |
| CQI 3 | 16 bits | 64 bits | 130 bits |
| CQI 4 | 24 bits | 94 bits | 186 bits |
| COI 5 | 40 bits | 148 bits | 294 bits |
| CQI 6 | 48 bits | 176 bits | 352 bits |
| CQI 7 | 60 bits | 226 bits | 454 bits |
| CQI 8 | 82 bits | 306 bits | 612 bits |
| CQI 9 | 110 bits | 406 bits | 814 bits |
| COI 10 | 118 bits | 436 bits | 870 bits |
| CQI 11 | 156 bits | 580 bits | 1158 bits |
| CQI 12 | 180 bits | 666 bits | 1332 bits |
| CQI 13 | 210 bits | 780 bits | 1562 bits |
| CQI 14 | 226 bits | 838 bits | 1678 bits |
| CQI 15 | 268 bits | 996 bits | 1994 bits |

In order to improve the efficiency of radio resource management, radio resources may be allocated based on a semi-persistent scheduling (SPS) scheme or a bundling scheme.

The slave XDU sector may perform a measurement operation and may transmit the measurement results to the master XDU sector in a periodic or event triggering manner. The slave XDU sector may measure radio channel qualities (e.g., RSSI, RSRP, CQI, CSI, etc.) for N candidate beams by performing a beam/channel estimation operation (e.g., beam/channel measurement operation). Here, N may be a positive integer. The N candidate beams may be composed of N beams satisfying a predetermined condition or N beams from a beam having the best radio channel quality measurement result. Also, the radio channel quality measurement procedure and the beam measurement procedure may be performed simultaneously. In addition, a buffer status or a buffer residence time of a head of line (HOL) packet may be measured for each XL-RB.

The master XDU sector may allocate radio resources in consideration of the buffer status information for each XL-RB, the buffer residence time of the HOL packet, the radio channel quality, and the like, which are received from the slave XDU sector, and may transmit information on the allocated radio resources to the slave XDU sector. The slave XDU sector may perform a priority handling function for a plurality of XL-RBs based on the radio resources allocated by the master XDU sector.

Meanwhile, in the access network and the Xhaul network, the radio resources may be configured as follows.

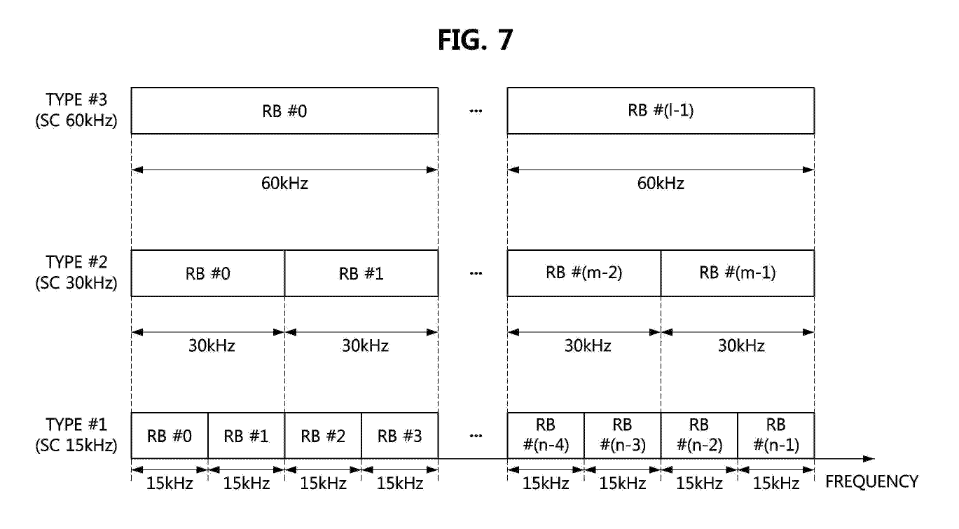

FIG. 7 is a conceptual diagram illustrating a first embodiment of radio resources configured for an access network and an Xhaul network.

Referring to FIG. 7, radio resources for XL and AL may be configured based on a multi-frame structure using subcarrier spacing (SC) alignment. For example, integrated radio resources for XL nodes and AL nodes may be configured in the same frequency band, and a radio frame structure of each network (e.g., each of the Xhaul network and the access network) may be configured based on a concept of multi-numerology in order to variably distribute (e.g., allocate) the integrated radio resources. By aligning subcarriers in a sub-set form, the radio resources in each network may be configured to a multiple of a minimum radio resource unit (e.g., may include a non-integer multiple of the minimum radio resource unit), or may be configured to maintain a constant mapping relationship with the minimum radio resource unit. Here, the minimum radio resource unit (e.g., minimum frame) unit may mean a radio resource unit configured in units of a scheduling unit such as a minimum SC, a minimum TTI, or the like.

The radio resource (e.g., a frame) may be configured based on a type #1, a type #2, and a type #3. The SC may be 15 kHz in the type #1, the SC may be 30 kHz in the type #2, and the SC may be 60 kHz in the type #3. For example, the AL node may configure radio resources based on the type #1, and the XL node may configure radio resources based on the type #2 and the type #3. Alternatively, the AL node may configure radio resources based on the type #1 and the type #2, and the XL node may configure radio resources based on the type #3. Therefore, the integrated radio resources for XL and AL may be variably configured or changed based on the type #1, the type #2 and the type #3.

Meanwhile, synchronization signals and system information for the access network (e.g., AL) and synchronization signals and system information for the Xhaul network (e.g., XL) may be transmitted as follows.

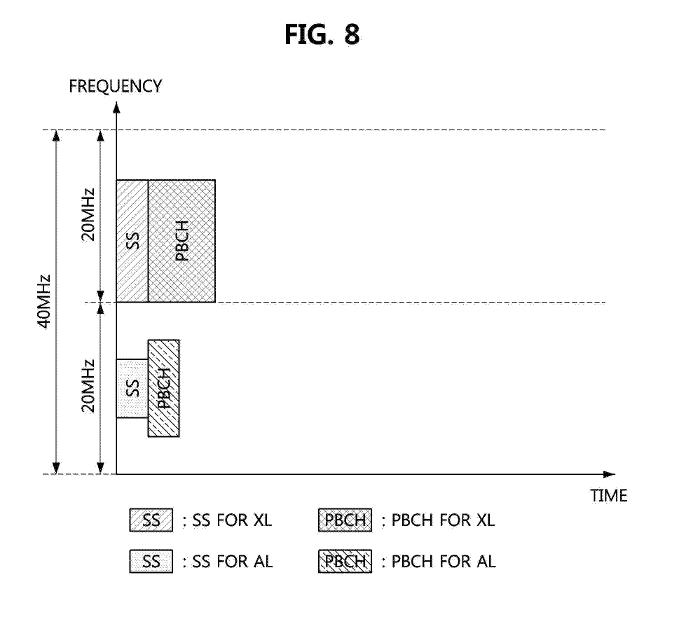

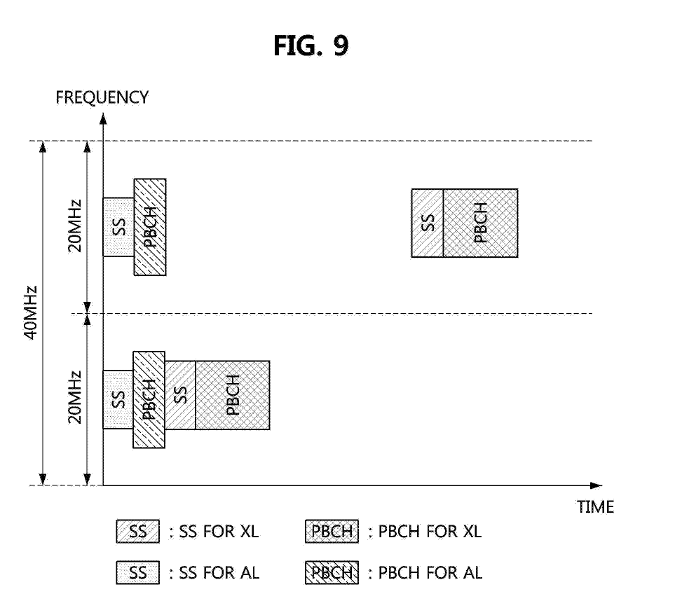

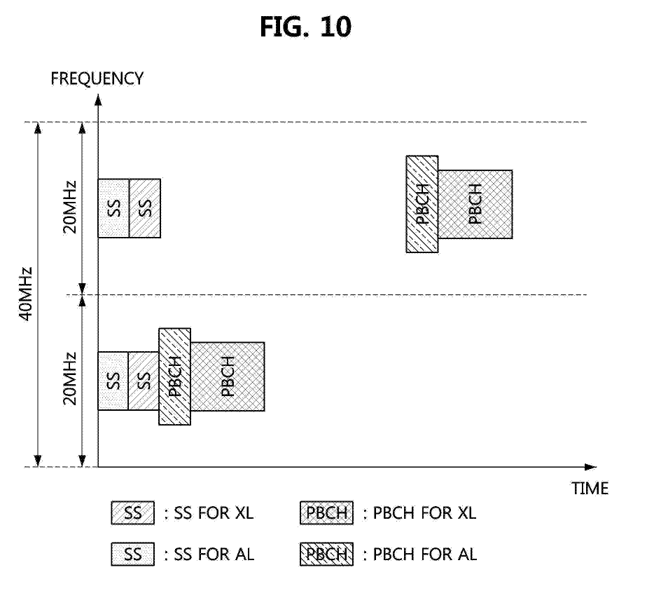

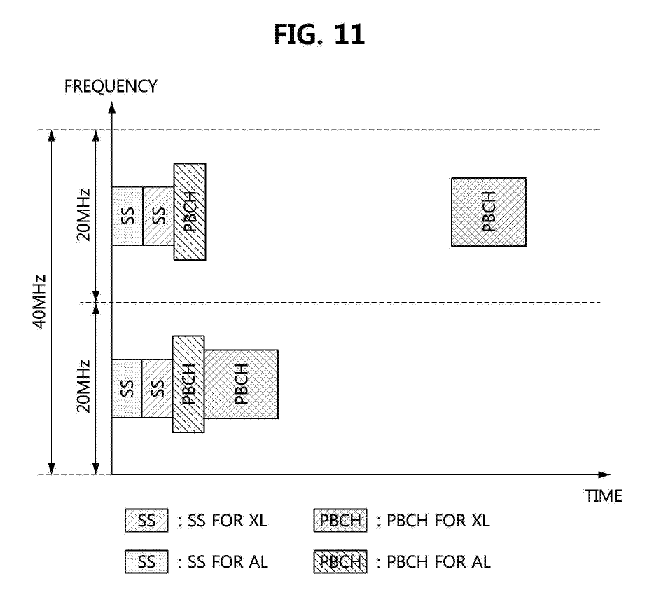

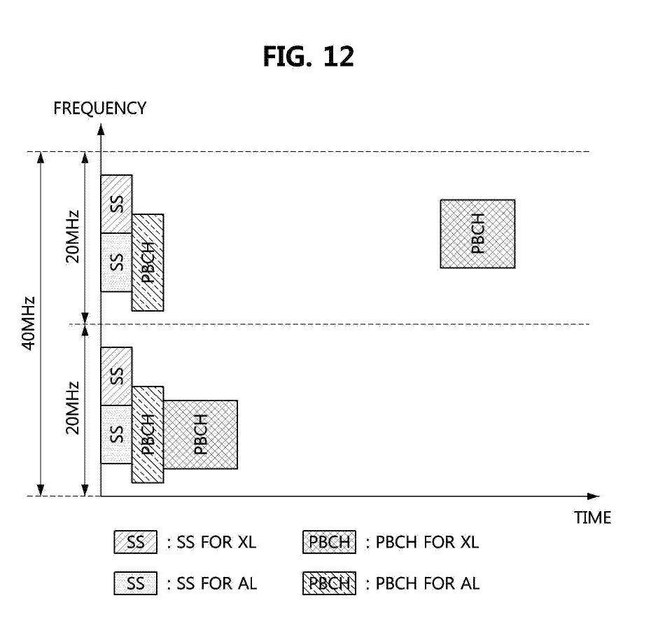

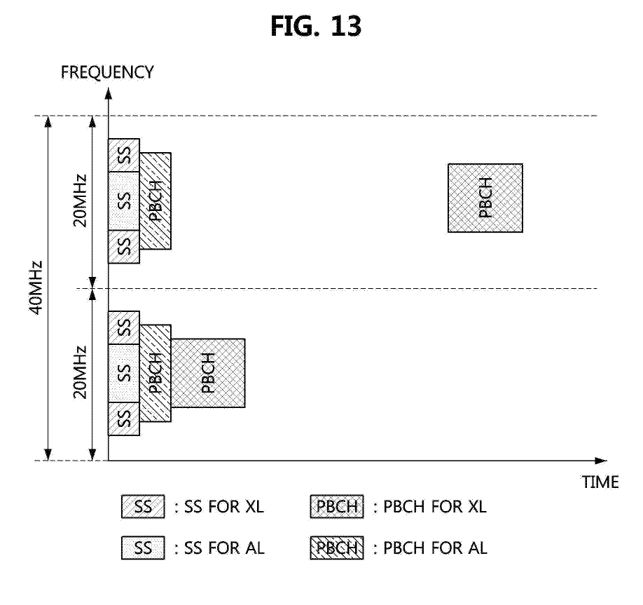

FIG. 8 is a conceptual diagram illustrating a first embodiment of a method of transmitting synchronization signals and system information in an integrated communication system, FIG. 9 is a conceptual diagram illustrating a second embodiment of a method of transmitting synchronization signals and system information in an integrated communication system, FIG. 10 is a conceptual diagram illustrating a third embodiment of a method of transmitting synchronization signals and system information in an integrated communication system, FIG. 11 is a conceptual diagram illustrating a fourth embodiment of a method of transmitting synchronization signals and system information in an integrated communication system, FIG. 12 is a conceptual diagram illustrating a fifth embodiment of a method of transmitting synchronization signals and system information in an integrated communication system, and FIG. 13 is a conceptual diagram illustrating a sixth embodiment of a method of transmitting synchronization signals and system information in an integrated communication system.

Referring to FIGS. 8 to 13, a synchronization signal (SS) may include a primary synchronization signal (PSS), a secondary synchronization signal (SSS), and the like, and system information may be transmitted through a physical broadcast channel (PBCH). The synchronization signal and the PBCH (SS/PBCH) may be transmitted at discrete time intervals by using the entire system bandwidth or a part of the system bandwidth. In FIG. 8, the system bandwidth of the Xhaul network may be 40 MHz, and the system bandwidth of the access network may be 20 MHz. In FIGS. 9 to 13, the system bandwidth of the Xhaul network may be 20 MHz, and the system bandwidth of the access network may be 20 MHz.

The frequency band in which the SS/PBCH for AL (hereinafter referred to as ‘AL SS/PBCH’) is transmitted may be different from the frequency band in which the SS/PBCH for XL (hereinafter referred to as ‘XL SS/PBCH’) is transmitted. Alternatively, the AL SS/PBCH and the XL SS/PBCH may be transmitted over the same frequency band. The time resource in which the AL SS/PBCH is transmitted may be different from the time resource in which the XL SS/PBCH is transmitted. For example, the AL SS/PBCH and the XL SS/PBCH may be transmitted using contiguous time resources or may be transmitted using discrete time resources. Alternatively, the AL SS/PBCH and the XL SS/PBCH may be transmitted over the same time resource, in which case the frequency band in which the AL SS/PBCH is transmitted may be different from the frequency band in which the XL SS/PBCH is transmitted.

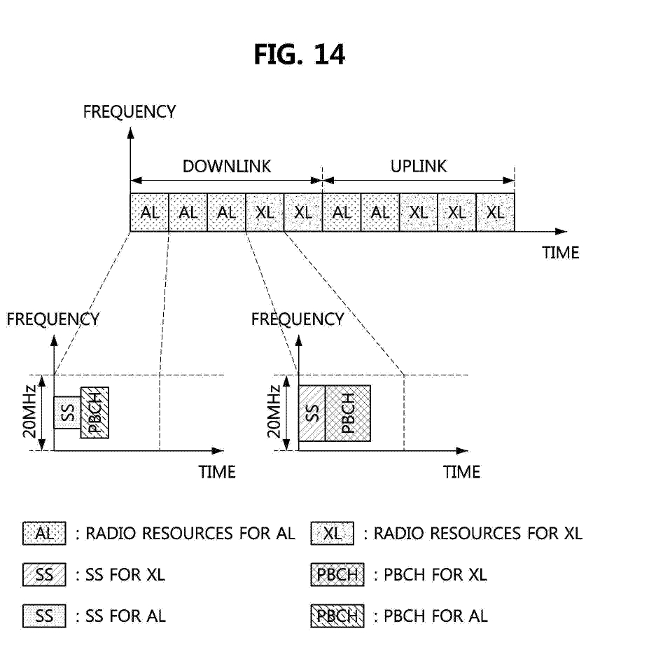

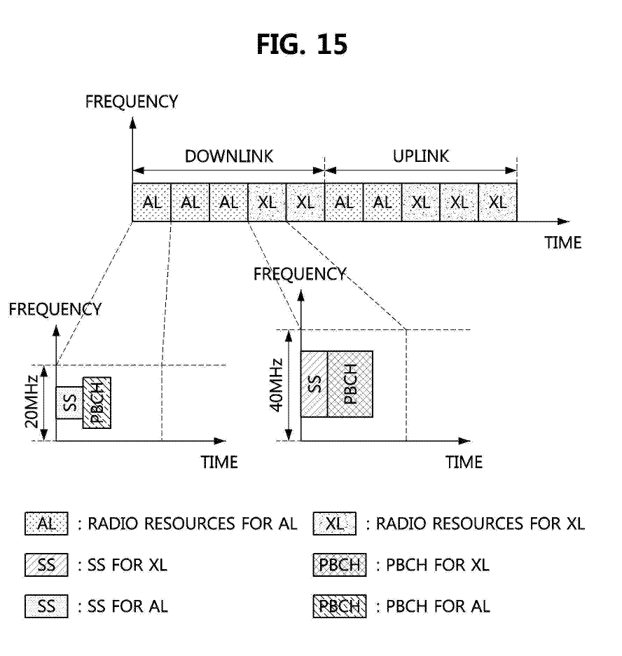

FIG. 14 is a conceptual diagram illustrating a first embodiment of an SS/PBCH transmission method in an integrated radio resource management based on a time division duplex (TDD) scheme, and FIG. 15 is a conceptual diagram illustrating a second embodiment of an SS/PBCH transmission method in an integrated radio resource management based on a TDD scheme.

Referring to FIGS. 14 and 15, an AL SS/PBCH may be transmitted through a radio resource for AL (hereinafter referred to as an ‘AL radio resource’), and an XL SS/PBCH may be transmitted through a radio resource for XL (hereinafter referred to as an ‘XL radio resource’). In FIG. 14, the size of the frequency band of the AL radio resource may be 20 MHz, and the size of the frequency band of the XL radio resource may be 20 MHz. In FIG. 15, the size of the frequency band of the AL radio resource may be 20 MHz, and the size of the frequency band of the XL radio resource may be 40 MHz. In the time domain, the AL radio resource and the XL radio resource may be configured according to a time unit (e.g., radio frame, subframe, TTI, slot, mini-slot, etc.). Also, a guard or a gap may be configured between radio resources (e.g., AL radio resources and XL radio resources).

Meanwhile, the AL node and the XL node may perform predefined functions for variably managing radio resources (e.g., AL radio resources and XL radio resources). For example, the MME may perform the following functions.
Non access stratum (NAS) signaling
Signaling between core network (CN) nodes for inter-access network mobility (e.g., mobility between 3GPP based access networks)
Reachability of a terminal operating in an idle mode (e.g., including execution and control of paging retransmission)
Selection of P-GW and S-GW
Management of a list of tracking areas (TAs)
Roaming
Bearer management
S-GW relocation without terminal mobility (e.g., interworking with load management)

Also, the MME may perform the following signaling functions through the NG_{MXN} interface for managing the integrated radio resources.
Resource block (RB) management
S-GW (re)location according to an XL path (re)configuration
The S-GW (re)location may be performed when a change of an XL path results in a change in an AL node associated with the XL path.

The base station (e.g., eNB, gNB, or ng-eNB) may perform an establishment function, a configuration function, a maintenance function, a management functions, and a QoS management function for the access link-radio bearer (AL-RB). Also, the base station (e.g., eNB, gNB, or ng-eNB) may perform the following signaling functions through the X_{MXN} interface for managing the integrated radio resources. The signaling message (e.g., a control message) of the base station (e.g., eNB, gNB, or ng-eNB) may be transmitted to an XDU (e.g., XDU sector) via the MME/XCU. Alternatively, the signaling message (e.g., a control message) of the base station (e.g., eNB, gNB, or ng-eNB) may be transmitted directly to an XDU (e.g., XDU sector) without passing through the MME/XCU.
Variable radio resource management decision function with XL node
Signaling function for variably configuring radio resources to MME and XL node
Information such as information on required allowable radio resource may be signaled.
Determining and requesting increase or decrease of allowable radio resources by monitoring occupation status (e.g., increase or decrease) of AL radio resources

Here, the allowable resources may indicate radio resources exclusive use of which are allowed for each of AL and XL among radio resources (e.g., AL radio resources and XL radio resources). Therefore, the allowable resources may be configured as a transmission time (e.g., a radio frame, a subframe, a TTI, a slot, a mini-slot, a symbol, etc.) and a transmission frequency band (e.g., a sub-band, a subcarrier, etc.). The AL node may use resources within the allowable resources when providing communication services using the AL. In this case, the allowable resources may be scheduled by the AL node. The XL node may use resources within the allowable resources when providing communication services using the XL. In this case, the allowable resources may be scheduled by the XL node.

Meanwhile, the XCU may perform an admission control function for activation of an XDU (e.g., XDU sector) and for establishment (or setup), configuration, modification, addition, release, or the like of an XL-RB. Also, the following functions may be performed for load control for each AL path.
Configuration of allowable resources for an XL path and determination of increase or decrease of the allowable resources for variable radio resource operation
Transferring information on allowable resources to a master XDU sector

The XDU may perform a triggering (e.g., request) procedure for increasing or decreasing the allowable resources by performing management functions on configuration information of the allowable resources among the XDUs (e.g., XDU sectors). For example, the XDU may perform the following functions for the triggering procedure.
Determination of a destination (e.g., XCU or AL node) of a triggering message (e.g., request message)
Transferring the triggering message (e.g., request message) to the corresponding node according to a predefined procedure

When the triggering message (e.g., request message) for an increase or decrease of the allowable resources is received at the XCU, the XCU may forward the triggering message (e.g., request message) to the AL node.

The master XL node may allocate radio resources in units of TTI considering QoS. For example, the master XL node may allocate radio resources such that fairness is guaranteed for XL-RBs having the same QoS. The slave XL node may perform a measurement and reporting operation of radio channel qualities and a measurement and reporting operation of buffer statuses based on the configured parameters, and perform a priority handling function for transmission XL-RBs.

Among the entire radio resources (e.g., AL radio resources and XL radio resources), the remaining radio resources other than radio resources for common information (e.g., system information) for each AL/XL node, synchronization signals, reference signals for the beam sweeping procedure, and reference signals for the radio channel quality measurement (or estimation) procedure may be variably allocated (e.g., distributed). Alternatively, the entire radio resources (e.g., AL radio resources and XL radio resources) may be variably allocated. The reference signal for the AL node may be transmitted using the radio resource allocated for the access network, and the reference signal for the XL node may be transmitted using the radio resource allocated for the Xhaul network.

In the access network and the Xhaul network, reference signals may be transmitted in the same pattern or a similar pattern. When the reference signal is transmitted via an adjacent radio resource, quality and interference of a radio channel may be measured based on the reference signal.

Even when a target (e.g., terminal) to which a communication service is provided does not exist, there may be a packet to be transmitted and received through radio resources between an AL node and an XL node corresponding to the AL node. For example, a packet for a relay function, a forwarding function, or a redundant transmission function based on a backup path may be transmitted and received using radio resources between an AL node (i.e., an AL node without a target to which a communication service is provided) and an XL node.

When an access restriction (i.e., access barring) is not configured to an AL node, a radio resource for an initial access procedure may always be allocated (or configured). However, even when an access restriction is applied to an AL node, a radio resource for an initial access for an emergency call may be allocated.

In an initialization phase of an AL node, a radio resource (e.g., a frequency-time resource) that can be used by an AL or XL node may be configured, and the AL or XL node may use the NG_{MXN} interface or the X_{MXN} interface to perform the following signaling procedure.

For example, the AL node may transmit capability information of the AL node to the XL node (e.g., XCU, XDU, XDU sector, etc.). The capability information of the AL node may include an identifier of the AL node, information indicating whether a wired S1 interface exists, a system bandwidth, a transmission power (TX power), information indicating whether a management function of the integrated radio resources is supported, or the like. Also, the capability information of the AL node may include information of the AL node (e.g., cell, sector, beam, beam group, etc.) deactivated according to a support of carrier aggregation (CA) or dual connectivity (DC) in consideration of multiple connectivity of the terminal to which a communication service is provided.

Here, the S1 interface may be an interface between the eNB and the MME/S-GW in the LTE communication system or the LTE-A communication system. The S1 interface may correspond to the NG interface between a node (e.g., gNB, ng-eNB) of the NG-RAN in the NR communication system and the AMF/UPF of the 5G core network. In the NR communication system, a NG2 reference point may be between the RAN and the AMF, and a NG3 reference point may be between the RAN and the UPF. The gNB (or ng-eNB) may perform a termination function of the RAN or the access network. Therefore, in the following embodiments, the S1 interface may be replaced with the NG interface.

Meanwhile, the XL node may acquire the capacity information of the AL node, and may transmit information of the XL node to the AL node (e.g., eNB, gNB, ng-eNB, etc.) in XDU or XDU sector units. The information of the XL node may include an identifier of the XL node, system information, state information of the XL node (e.g., master state, slave state, idle state, etc.). The identifier of the XL node may be defined as follows.
MME XCU NG_{MXN}AP ID (or, AMF XCU NG_{MXN}AP ID)
MME XCU NG_{MXN}AP ID (or, AMF XCU NG_{MXN}AP ID) may be an identifier used for the MME (or, AMF) to uniquely identify an XCU in the NG_{MXN} interface.
MME XDU NG_{MXN}AP ID (or, AMF XDU NG_{MXN}AP ID)
MME XDU NG_{MXN}AP ID (or, AMF XDU NG_{MXN}AP ID) may be an identifier used for the MME (or, AMF) to uniquely identify an XDU in the NG_{MXN} interface.
NB XDU X_{MXN}AP ID
NB XDU X_{MXN}AP ID may be an identifier used for the AL node to uniquely identify an XDU in the X_{MXN} interface.
MXN XDU X_{MXN}AP ID
MXN XDU X_{MXN}AP ID may be an identifier used for the node (e.g., XCU) belonging to the Xhaul network to uniquely identify an XDU in the X_{MXN} interface.
Old MME XDU/XDU_{Sector} NG_{MXN}AP ID
Old MME XDU/XDU_{Sector} NG_{MXN}AP ID may be an identifier used for uniquely identifying a source XDU or XDU sector in a mobility function support procedure (e.g., handover procedure).
New MME XDU/XDU_{Sector} NG_{MXN} AP ID
New MME XDU/XDU_{sector} NG_{MXN}AP ID may be an identifier used for uniquely identifying a target XDU or XDU sector in a mobility function support procedure (e.g., handover procedure).
MXN XCU/XDU/XDU Sector ID
MXN XCU/XDU/XDU Sector ID may be an identifier used for uniquely identifying an XCU, an XUD, or an XDU sector in the Xhaul network.

Also, the information of the XL node may include an average utilization/load status of radio resources, transmission and reception buffer status information, information on radio resources reserved for a backup path, or the like.

The AL or XL node may perform an admission control function, an access baring (AB) function, an access class barring (ACB) function, or the like within a range of allowable resources (e.g., frequency resource, time resource, beam, etc.) of each link (e.g., AL or XL) configured through the initialization phase (or, change procedure). Also, the AL or XL node may variably use the integrated radio resources by triggering a change of the allowable resources configured between the AL and the XL using headroom parameters or threshold information for the allowable resources. The AL node may perform access control in conjunction with the MME (e.g., AMF), and the XL node may perform load control in conjunction with the XCU (e.g., xRM included in the XCU). The xRM may perform the admission control function, the load control function, the measurement function, the authentication function, or the like.

When the AL node and the XL node provide communication services using the same frequency band, the AL node may perform a distribution (or allocation) function on the integrated radio resources. That is, the AL node may variably configure the allowable resources. The integrated radio resources may be radio resources commonly used by the access network and the Xhaul network, the allowable resources may be configured within the integrated radio resources, and the allowable resources for the AL nodes may be configured to be orthogonal to the allowable resources for the XL nodes. In this case, the AL node may configure the radio resources considering the influence of the characteristics of the XL node. For example, the AL node may consider a required latency, a capacity, a data rate, or the like depending on the level of functional isolation between DU and RU in the fronthaul link. Also, the AL node may determine a signaling message and a signaling procedure in consideration of the type of X_{MXN} interface (e.g., X2 (or Xn) interface) or the NG_{MXN} interface (e.g., S1 (or NG) interface).

Meanwhile, when the AL node and the XL node use the same frequency band, the signaling procedure for variably managing the integrated radio resources may be performed as follows.

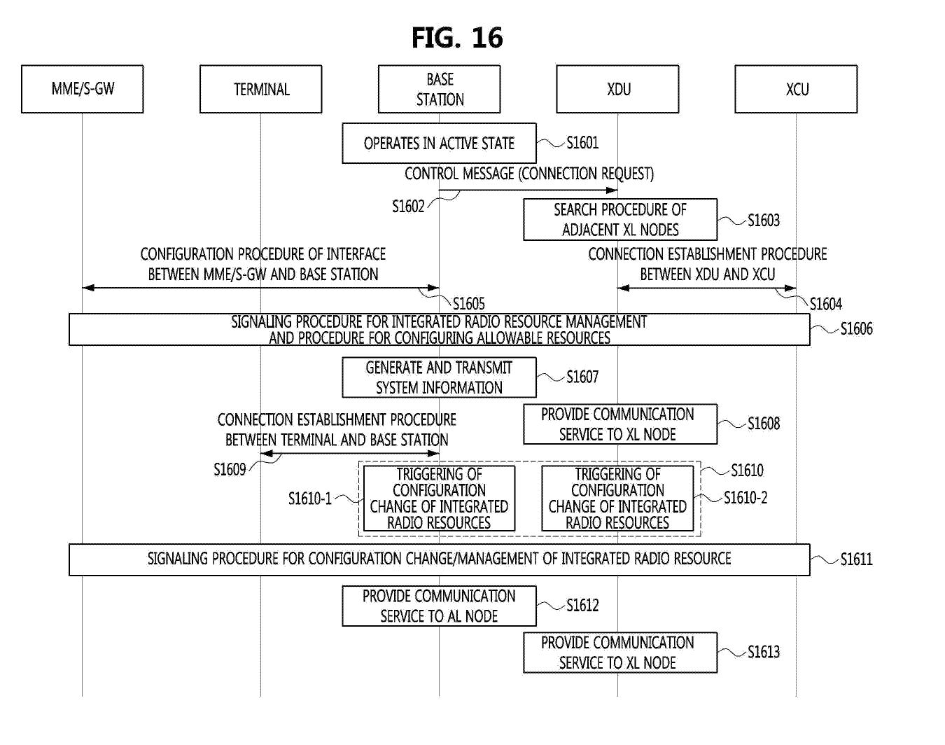

FIG. 16 is a sequence chart illustrating a first embodiment of a signaling procedure for variably managing integrated radio resources.

Referring to FIG. 16, an integrated communication system may comprise a terminal, a base station (eNB, gNB, or ng-eNB), an MME/S-GW (e.g., AMF/UPF), an XDU (e.g., XDU sector), an XCU, and the like. The base station may interwork with the XDU, and the terminal may be located in a service area of the base station. Each of the terminal, the base station, the MME/S-GW, the XDU, and the XCU may perform the functions described above.

When power is supplied to the base station, an operation state of the base station (e.g., base station without the S1 interface (or NG interface)) may transition from an inactive state to an active state (S1601). The XDU interworking with the base station may be registered in the XCU of the Xhaul network irrespective of the operation state of the base station (e.g., the active state) and may be connected to another XDU to perform communications. The base station operating in the active state may transmit a control message requesting connection with the core network to the XDU using the XL (S1602). In the step S1602, the control message may include an identifier of the base station, information indicating whether the S1 (or NG) interface exists, a system bandwidth, a transmission power, information indicating whether a management function of integrated radio resource is supported, measurement information for adjacent AL nodes, or the like. Here, the information indicating whether the S1 (or NG) interface exists may indicate whether the corresponding node (e.g., the base station) performs maintenance and configuration functions for the S1 (or NG) interface through a wired path. Also, the information indicating whether the management function of integrated radio resources is supported may indicate whether or not a communication service through the AL and XL using the same frequency band is supported.

The XDU may receive from the base station the control message requesting a connection with the core network. When the connection between the XDU and the XCU is not configured, the XDU may perform a search procedure for an adjacent XL node (S1603). For example, the XDU may receive a signal from an adjacent XL node (e.g., adjacent XCU) and may identify the adjacent XL node (e.g., adjacent XCU) based on information (e.g., identifier) included in the received signal. The XDU may perform a connection establishment procedure with the discovered XCU (S1604). On the other hand, when the connection between the XDU and the XCU is configured, the XDU may use an already-configured XL-RB without performing the steps S1603 and S1604. Alternatively, even when the connection between the XDU and the XCU is configured, the XDU may add a new XL-RB by performing the step S1604. Also, the steps S1602 to S1604 may be performed through a plurality of XDUs, in which case the XL may be configured based on a multi-hop function.

When the connection establishment procedure between the XCU and the XDU interworking with the base station is completed, the base station may configure the S1 interface with the MME/S-GW (S1605). For example, the base station may be registered in the MME/S-GW, and the S1 interface may be configured by performing a connection establishment procedure between the base station and the MME/S-GW. When it is determined that the AL node (e.g., base station) and the XL node (e.g., XCU or XDU) use the same frequency band to provide communication services, a signaling procedures for the management of integrated radio resources, and a configuration procedure of allowable resources may be performed (S1606). In the step S1606, the integrated radio resources and the allowable resources may be configured. The integrated radio resources may be a frequency band commonly used by the access network (e.g., AL nodes) and the Xhaul network (e.g., XL nodes), and the allowable resources may be configured within the integrated radio resources. The allowable resources for the access network and the allowable resources for the Xhaul network may be set to be orthogonal to each other.

In the step S1606, the integrated radio resources and the allowable resources may be configured based on the radio resource configuration method described with reference to FIG. 7. The step S1606 may be performed by the MME/S-GW, the base station, the XDU, and the XCU, and may be performed using the NG_{MXN} signaling messages or the X_{MXN} signaling messages. The NG_{MXN} signaling messages may include the MME configuration transfer message, the XCU status transfer message, the XCU configuration transfer message, or the like. The X_{MXN} signaling messages may include the NB status transfer message, the NB configuration transfer message, the NB configuration update message, the resource status update message, the XDU status transfer message, the XDU configuration transfer message, the XDU configuration update message, and the like described above.

The AL node may transmit information of the AL node (e.g., identifier, system information, status information of the AL node, resource configuration information of the physical layer, etc.) to the XL node through the NG_{MXN} or X_{MXN} signaling message. Therefore, the XL node may identify the information of the AL node based on the NG_{MXN} or X_{MXN} signaling message received from the AL node. The XL node may transmit information of the XL node (e.g., identifier, system information, status information of the XL node, resource configuration information of the physical layer, etc.) to the AL node through the NG_{MXN} or X_{MXN} signaling message. Therefore, the AL node may identify the information of the XL node based on the NG_{MXN} or X_{MXN} signaling message received from the XL node.

In the step S1606, when the signaling procedure for the management of the integrated radio resources and the procedure for configuring the allowable resources are performed, one of the AL node and the XL node may be configured to be a primary node leading the distribution (or, allocation) function of the integrated radio resources. The primary node may be defined by the integrated communication system. Alternatively, the primary node may be selected by a service provider providing the communication services.

In the step S1606, the signaling procedure for the management of the integrated radio resources and the procedure for configuring the allowable resources may be performed by at least one node (e.g., a node supporting such the functions) among the MME/S-GW, the base station, the XDU, and the XCU. For example, in the step S1606, the signaling procedure for the management of the integrated radio resources and the procedure for configuring the allowable resources may be performed by the base station, the XDU, and the XCU. Alternatively, the signaling procedure for the management of the integrated radio resources and the procedure for configuring the allowable resources may be performed by the base station and the XDU. Also, the base station operating as the primary node may performs the signaling procedure for the management of the integrated radio resources and the procedure for configuring the allowable resources of the step S1606 with another base station maintaining the S1 (or NG) interface with the MME/S-GW.

In the step S1606, the integrated radio resources and the allowable resources may be configured in consideration of the capacity information of the AL node or the XL node. The capability information of each of the AL node and the XL node may include information on an operation specification and system version, a transmission frequency, a system bandwidth, a transmission power, a capability of a peer node, or the like, and the parameters and parameter values (e.g., ranges) for each of the integrated radio resources and the allowable resources may be determined in consideration of the capability information (e.g., the capability information of the AL node or the capability information of the XL node).

When the step S1606 is completed, the base station may generate system information and transmit the system information so that the terminal belonging to the service area of the base station can receive the system information (S1607). The system information of the base station may be transmitted through the allowable resources configured in the step S1606. For example, the base station may transmit the system information (or synchronization signal, control information, data, or the like) based on the transmission method described with reference to FIGS. 8 to 15. Also, when the step S1606 is completed, the XDU may provide necessary communication services in the Xhaul network using the allowable resources configured in the step S1606 (S1608). For example, the XDU may transmit the system information (or synchronization signal, control information, data, or the like) based on the transmission method described with reference to FIGS. 8 to 15.

The terminal may receive the system information from the base station, and may perform a connection establishment procedure with the base station based on the system information (S1609). When the connection establishment procedure is completed, the AL-RB may be configured between the terminal and the base station. Here, the terminal may be a device supporting an IoT function, a device supporting a device to device (D2D) function, a device supporting a MTC function, or a device supporting a vehicle to anything (V2X) communication function. The base station may provide necessary communication services to the terminal using the allowable resources configured in the step S1606.

Meanwhile, when it is required to change the communication service being provided to the terminal, when it is required to change the configuration of the integrated radio resources (e.g., allowable resources) in order to provide the communication service to a new terminal, or when a predetermined triggering condition is satisfied, the base station may transmit a triggering message requesting a change of the integrated radio resources (e.g., allowable resource) (S1610-1). The triggering message of the base station may be transmitted to the nodes that performed the step S1606 (e.g., AL node and XL node). Accordingly, the nodes participating in the signaling procedure for the management of the integrated radio resources and the procedure for configuring the allowable resources in the step S1606 may receive the triggering message from the base station, and may identify that the change of the integrated radio resources (e.g., allowable resources) has been requested based on the triggering message.

Also, when a change of the configuration of the integrated radio resources (e.g., allowable resources) is required during the provision of the communication service in the Xhaul network, or when a predetermined triggering condition is satisfied, the XDU may transmit a triggering message requesting the change of the integrated radio resources (e.g., allowable resources) (S1610-2). The triggering message of the XDU may be transmitted to the nodes that performed the step S1606 (e.g., AL node and XL node). Accordingly, in the step S1606, the node participating in the signaling procedure for the management of the integrated radio resources and the procedure for configuring the allowable resources may receive the triggering message from the XDU, and may identify that the change the integrated radio resources (e.g., allowable resources) has been requested based on the triggering message.

In response to the request of the change of the integrated radio resources (e.g., allowable resources) from the base station or the XDU, the corresponding nodes (e.g., the AL node and the XL node participating the step S1606) may perform signaling procedures for changing or managing the integrated radio resources (e.g., allowable resources) (S1611). In the step S1611, the nodes participating in the signaling procedure for changing or managing the configuration of the integrated radio resources may exchange the NG_{MXN} or X_{MXN} signaling messages.

In the step S1611 (or, the step S1606), the NG_{MXN} or X_{MXN} message may include the capacity information of each of the AL node and the XL node. The capability information of each of the AL node and the XL node may include an identifier of the node (e.g., AL node or XL node), information indicating whether the S1 interface exists, information on an operation specification and system version, a transmission frequency, a system bandwidth, a transmission power, information indicating whether a management function for the integrated radio resources is supported, or the like. Also, the capability information may further include information on the AL nodes (e.g., cell, sector, beam, beam group, etc.) deactivated by a support of CA or DC in consideration of multiple connectivity of the terminal to which a communication service is provided.

When the step S1611 is completed, the base station may provide the communication service to the terminal by using the changed integrated radio resources (e.g., changed allowable resources) (S1612). For example, the base station may transmit the system information (or synchronization signal, control information, data, or the like) based on the transmission method described with reference to FIGS. 8 to 15. Also, when the step S1611 is completed, the XDU may provide the communication service in the Xhaul network using the changed integrated radio resources (e.g., changed allowable resources) (S1613). For example, the XDU may transmit the system information (or synchronization signal, control information, data, or the like) based on the transmission method described with reference to FIGS. 8 to 15.

Meanwhile, the signaling procedure for variably managing the integrated radio resources in the communication system comprised of only AL nodes may be performed as follows.

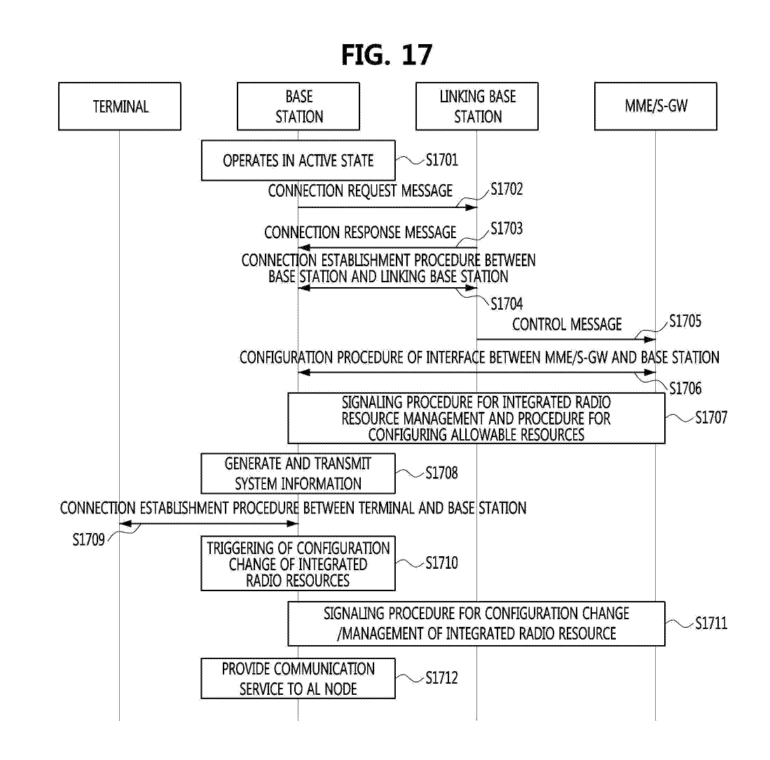

FIG. 17 is a sequence chart illustrating a second embodiment of a signaling procedure for variably managing integrated radio resources.

Referring to FIG. 17, an integrated communication system may comprise a terminal, a base station (e.g., eNB, gNB, or ng-eNB), a linking base station (e.g., eNB, gNB, or ng-eNB), an MME/S-GW (e.g., AMF/UPF), and the like. The base station may be located in the access network illustrated in FIG. 4 or 5. The linking base station may be referred to as a “donor base station.” The linking base station may be located in the Xhaul network illustrated in FIG. 4 or 5, and may support communications between the base station belonging to the access network and the MME/S-GW belonging to the core network. The base station may perform communications using the AL, and the linking base station may perform communications using the XL. The radio resources of each of the AL and the XL may be defined in the form of cell, sector, RRH, TRP, beam, beam group, or the like. The linking base station may be a base station supporting a relay function or a general base station. When the linking base station is a general base station, the linking base station may provide communication services to the terminals located in its service area independently of the base station. An S1 (or NG) interface for the linking base station may exist, and the linking base station may provide communication services for the configuration of the base station's S1 interface.

When a communication service is provided using the integrated wireless resources in the communication system composed solely of AL nodes, the communication service may be provided based on the radio resources described with reference to FIG. 7 and the transmission method described with reference to FIGS. 8 to 15. For example, the base station may configure RBs based on the type #1, and the linking base station may configure RBs based on the type #2 or the type #3. In this case, the integrated radio resources for the AL and the XL may be variably configured in multiples of 30 kHz (i.e., frequency resources based on the type #2) or 60 kHz (i.e. frequency resources based on the type #3) in the frequency domain, and the communication service may be provided through the configured integrated radio resource (e.g., allowable resources belonging to the integrated radio resources). Alternatively, the base station may configure RBs based on the type #1 and the type #2, and the linking base station may configure RBs based on the type #3. In this case, the integrated radio resources for the AL and the XL may be variably configured in multiples of 60 kHz (i.e. frequency resources based on the type #3) in the frequency domain, and the communication service may be provided through the configured integrated radio resources (e.g., allowable resources belonging to the integrated radio resources).

In FIGS. 8 to 15, an SS for AL may indicate a synchronization signal transmitted by the base station to the terminal belonging to its service area, and a PBCH for AL may indicate a PBCH used for the base station to transmit system information to the terminal belonging to its service area. An SS for XL may indicate a synchronization signal transmitted by the linking base station to the terminal belonging to its service area, and a PBCH for XL may indicate a PBCH used for the linking base station to transmit system information to the terminal belonging to its service area.

When power is supplied to the base station without the S1 (or, NG) interface, an operation state of the base station may transition from an inactive state to an active state (S1701). The base station operating in the active state may search for adjacent nodes in order to connect to the core network. For example, the base station may receive a signal from an adjacent base station (e.g., linking base station) and may identify the adjacent base station based on information (e.g., identifier) included in the received signal. The base station may perform a connection establishment procedure with the discovered linking base station. In the connection establishment procedure, the base station may transmit a connection request message to the linking base station (S1702). The linking base station may receive the connection request message from the base station, and may transmit a connection response message to the base station in response to the connection request message (S1703). The base station may receive the connection response message from the linking base station. After that, the connection establishment between the base station and the linking base station may be completed (S1704).

When the connection establishment between the base station and the linking base station is completed, the base station may transmit a control message for configuring the S1 interface to the linking base station. The linking base station may receive the control message for configuring the S1 interface from the base station, and may transmit the control message to the MME/S-GW (S1705). The MME/S-GW may receive the control message from the linking base station, and confirm that the configuration of the S1 interface of the base station is requested based on the control message.

Then, the base station may configure the S1 interface with the MME/S-GW (S1706). For example, the base station may be registered in the MME/S-GW and the S1 interface may be configured by performing a connection establishment procedure between the base station and the MME/S-GW. The connection establishment procedure may be performed based on a multi-hop function. For example, the base station may perform the connection establishment procedure with the MME/S-GW through a plurality of linking base stations.

When it is determined that the base station and the linking base station provide communication services using the same frequency band, a signaling procedure for management of the integrated radio resources and a procedure for configuring the allowable resources may be performed (S1707). In the step S1707, signaling messages for the management of the integrated radio resources may be exchanged between the base station, the linking base station, and the MME/S-GW so that the integrated radio resources and the allowable resources may be configured. The integrated radio resources may be a frequency band commonly used by the access network (e.g., base station) and the Xhaul network (e.g., linking base station), and the allowable resources may be configured within the integrated radio resources. The allowable resources for the access network and the allowable resources for the Xhaul network may be set to be orthogonal to each other.

In addition, the base station may transmit capability information in the steps S1702, S1706, and S1707. The capability information of the base station may include an identifier of the base station, information indicating whether the S1 interface exists, information on operation specification and system version, a transmission frequency, a system bandwidth, beam configuration information according to a beamforming technique, a transmission power, information indicating whether a management function for the integrated radio resources is supported, or the like. Also, the capability information may further include information on the AL nodes (e.g., cell, sector, beam, beam group, etc.) deactivated by a support of CA or DC in consideration of multiple connectivity of the terminal to which a communication service is provided.

The steps S1702, S1706, and S1707 may be performed using a signaling message (hereinafter, referred to as ‘IAB signaling message’) for the integrated radio resource management. The IAB signaling message may include the NB status transfer message, the NB configuration transfer message, the NB configuration update message, the resource status request message, the resource status update message, the MME status transfer message, and the MME configuration transfer message described above. In a signaling procedure for configuring and managing the integrated radio resources, the IAB signaling message may be reconfigured by adding sub-parameters to the IAB signaling message, or the IAB signaling message may be reconfigured by selectively combining sub-parameters of the IAB signaling message.

Also, information on each of the base station, the linking base station, and the MME/S-GW may be transmitted through the IAB signaling message. In this case, the IAB signaling message may be used to transmit an identifier (e.g., a physical layer identifier, a higher layer identifier, etc.) of the base station or the linking base station, system information, an operation state (or, connection state) of the base station, configuration information of resources for a radio access procedure, configuration information of a physical layer resource including a synchronization signal and a reference signal, or the like.

In the step S1707, when the signaling procedure for the management of the integrated radio resources and the procedure for configuring the allowable resources are performed, one of the base station, the linking base station, and the MME/S-GW may be configured to be a primary node leading the distribution (or, allocation) function of the integrated radio resources. The base station maintaining the S1 interface with the core network may be set as the primary node. For example, when the S1 interface between the base station and the MME/S-GW is configured through the linking base station, the base station may perform the function of the primary node. The primary node may be defined by the integrated communication system. Alternatively, the primary node may be selected by a service provider providing the communication services. The primary node may be determined based on a signaling procedure between the nodes or functions supported by the nodes.

In the step S1707, the signaling procedure for the management of the integrated radio resources and the procedure for configuring the allowable resources may be performed by at least one node (e.g., a node supporting such the functions) among the base station, the linking base station, and the MME/S-GW. For example, in the step S1707, the signaling procedure for the management of the integrated radio resources and the procedure for configuring the allowable resources may be performed by the base station and the MME/S-GW. Alternatively, in the step S1707, the signaling procedure for the management of the integrated radio resources and the procedure for configuring the allowable resources may be performed by the base station and the linking base station. Also, for the signaling procedure for the management of the integrated radio resources and the procedure for configuring the allowable resources, information on a service to be provided to the terminal, the capability information, the class, and the type of the terminal, or the like may be transmitted to the primary node.

In the step S1707, the integrated radio resources and the allowable resources may be configured in consideration of the capacity information of the base station or the linking base station. Also, parameters and parameter values (e.g., ranges) for the integrated radio resources and the allowable resources may be determined in consideration of the capability information of each of the base station and the linking base station. The capability information may include a system bandwidth, a transmission power, beam configuration information according to a beamforming technique, or the like.

When the step S1707 is completed, the base station may generate system information and transmit the system information so that the terminal belonging to the service area of the base station can receive the system information (S1708). The system information of the base station may be transmitted through the allowable resources configured in the step S1707. For example, the base station may transmit the system information (or synchronization signal, control information, data, or the like) based on the transmission method described with reference to FIGS. 8 to 15.

The terminal may receive the system information from the base station, and may perform a connection establishment procedure with the base station based on the system information (S1709). When the connection establishment procedure is completed, the AL-RB may be configured between the terminal and the base station. Here, the terminal may be a device supporting an IoT function, a device supporting a D2D function, a device supporting a MTC function, or a device supporting a V2X communication function. The base station may provide necessary communication services to the terminal using the allowable resources configured in the step S1707.

Meanwhile, when it is required to change the communication service being provided to the terminal, when it is necessary to change the configuration of the integrated radio resources (e.g., allowable resources) in order to provide the communication service to a new terminal, or when a predetermined triggering condition is satisfied, the base station may transmit a triggering message requesting a change of the integrated radio resources (e.g., allowable resource) (S1710). The trigger message of the base station may be transmitted to the nodes that performed the step S1707 (e.g., linking base station and MME/S-GW). Accordingly, the nodes participating in the signaling procedure for the management of the integrated radio resources and the procedure for configuring the allowable resources in the step S1707 may receive the triggering message from the base station, and may identify that the change of the integrated radio resources (e.g., allowable resources) has been requested based on the triggering message.

In response to the request of the change of the integrated radio resources (e.g., allowable resources) from the base station, the corresponding nodes (e.g., the linking base station and the MME/S-GW participating in the step S1707) may perform signaling procedures for changing or managing the integrated radio resources (e.g., allowable resources) (S1711). In the step S1711, the nodes participating in the signaling procedure for changing or managing the configuration of the integrated radio resources may exchange the IAB signaling messages. The IAB signaling messages used in the step S1711 may be a part of the IAB signaling messages used in the step S1707, and may include some information among the information included in the IAB signaling message used in the step S1707.

On the other hand, the step S1710 may be omitted, and in this case also, the primary node may perform the signaling procedure for changing or managing the integrated radio resources (e.g., allowable resource) based on a monitoring result on the parameters related to the configuration of the integrated radio resources or measurement report information. Even if the step S1710 is omitted, the IAB signaling message may be used for configuring or managing the configuration of the integrated radio resources (e.g., allowable resources).

When the step S1711 is completed or the configuration of the integrated radio resources (e.g., allowable resources) is changed without the step S1710, the base station may provide the communication service to the terminal using the changed integrated radio resources (e.g., changed allowable resources) (S1712).

Meanwhile, the following parameters and conditions may be considered in the signaling procedures for the variable management of the integrated radio resources illustrated in FIG. 16 and FIG. 17. In the triggering procedure for changing the configuration of the integrated radio resources (e.g., allowable resources) in the steps S1610 and S1710, the reference parameters and conditions may be configured as follows.
A case when an (average) occupancy rate or a change (or variance) rate (increase or decrease) of the allowable resources reaches a reference value
A case when an (average) utilization rate of the radio resources reaches a threshold
A case where a transmission reliability or a QoS reference condition meets a predefined criterion
For example, a block error rate (BLER), (average) latency time, a transmission buffer residence time, or the like
Recognition of activation or inactivation of a node in each link

The occupancy rate or the change rate (or variance rate) of the allowable resources may be measured as an occupancy rate or a change rate (or variance rate) for a predefined reference time during service provision. Here, the reference time may be configured based on a minimum scheduling period (e.g., a radio frame, a subframe, a TTI, a slot, a mini-slot, a symbol, etc.). For example, when the reference time is configured in units of subframes, the reference time may be set to N subframes. Here, N may be a positive integer or a real number. The occupancy rate or the change rate (or variance rate) of the allowable resources may be measured in a plurality of measurement periods, and when the measurement result meets a predefined condition, the corresponding node may transmit the triggering message in the steps S1610 and S1710. The measurement period may indicate the reference time described above.

For example, when three measurement periods are used to change the configuration of the integrated radio resources (e.g., allowable resources), the occupancy rate or the change rate (or variance rate) of the allowable resources may be measured for each measurement period. If the occupancy rates or the change rates (or variance rates) of the allowable resources in the three measurement periods all conform to the configuration change condition of the integrated radio resources, the corresponding node may transmit the triggering message in the steps S1610 and S1710.

In addition, when the change rates (or variance rates) of the allowable resources are increased in all of the three measurement periods, when the change rates (or variance rates) of the allowable resources are decreased in all of the three measurement periods, or when fluctuation widths of the change rates (or variance rates) of the allowable resources meet a reference condition in all of the three measurement periods, the corresponding node may transmit the triggering message in the steps S1610 and S1710. When there are at least one measurement period in which the change rate (or variance rate) of allowable resources is increased and at least one measurement period in which the change rate (or variance rate) of allowable resources is decreased in three measurement periods, the corresponding node may not transmit the triggering message in the steps S1610 and S1710.

The occupancy rate (or change rate, variance rate) of the allowable resources and the utilization rate of the radio resources may be configured for all services being provided or for services (e.g., guaranteed bit rate (GBR) services) that should guarantee a constant transmission rate.

It may be determined based on the BLER, the latency time, the transmission buffer residence time, or the like whether the transmission reliability or the QoS reference condition of a node in each link meets a predefined reference. When the measured value of the BLER of the serving service, the latency time, or the transmission buffer residence time meets the predefined criterion, the corresponding node may transmit the triggering message in the steps S1610 and S1710. The transmission buffer residence time may be the residence time of the HOL packet located in the buffer.

The average values may be measured in the measurement procedure of the parameters described above and the transmission of the triggering message may be controlled based on the measured average values. The parameters may be included in the configuration related parameters of the integrated radio resources, and the measurement results of the parameters may be periodically reported. Alternatively, the measurement results of the parameters may be reported non-periodically based on an event triggering scheme. If the measurement results of the parameters meet the reference condition, a triggering message including the measurement results of the parameters or a predefined triggering message may be transmitted in the steps S1610 and S1710.

Meanwhile, the IAB signaling message in the signaling procedures of the steps S1606, S1611, S1707 and S1711 may include the above-described configuration information of the allowable resources for each link described above. The configuration information of the allowable resources for each link may include parameters (e.g., a subcarrier, a radio frame, a subframe, a TTI, a slot, a mini-slot, a symbol, etc.) indicating radio resource regions constituting the allowable resources for the corresponding link.

The IAB signaling message may include a reference parameter and a reference parameter value (e.g., range) used to determine the triggering condition for the change of the configuration of the integrated radio resources (e.g., allowable resources). In addition, the IAB signaling message may include a radio channel quality of each link, a pattern of reference signals for measuring interfering signals, a transmission power, transmission region information (e.g., subcarrier index, transmission time index, offset, etc.), or the like. In addition, the IAB signaling message may include information according to a beamforming technique applied to each node (e.g., beam configuration information, beam index, etc.), or the like. Here, the beam configuration information may include a beam width, a beam transmission angle (or, beam transmission direction), a beam transmission pattern, a beam transmission region (e.g., subcarrier index, transmission time index, offset, etc.), a beam sweeping region, a transmission power, etc. of each node.

Meanwhile, the procedure for configuring the integrated radio resources may be suspended, released, or terminated in the following cases. In these cases, each of AL and XL may provide communication services using an independent frequency band. Alternatively, the integrated radio resources for AL and XL may be reconfigured after the AL and XL frequency bands are changed.
A case when the base station terminates service provision using AL
A case when the operation state of the base station transitions to the inactive state
A case when the base station and the linking base station respectively determine or request suspension or release of the management function of the integrated radio resources
A case when the interfering signal and the radio channel quality measured by the terminal, the base station or the linking base station meet the conditions for suspending, releasing, or terminating the configuration of the integrated radio resources
A case when the primary node determines to suspend or release the management function of the integrated radio resources
A case when the MME/S-GW (or, AMF/UPF) determines to suspend or release the management function of the integrated radio resources

The message for suspending, releasing, or terminating the configuration of the integrated radio resources may be transmitted and received among the base station, the linking base station, and the MME/S-GW. The procedure for suspending, releasing or terminating the configuration of the integrated radio resources may be performed based on the step S1611 in FIG. 16 or the step S1711 in FIG. 17. When the configuration of the integrated radio resources is suspended, released, or terminated, the base station in FIGS. 16 and 17 may transition to a power off state or operate in the inactive state. Also, the base station may perform a discontinuous transmission and reception operation for a low power consumption.

The discontinuous transmission and reception operation for the low power consumption may be a discontinuous reception (DRX) operation or a discontinuous transmission (DTX) operation performed based on a predetermined cycle or a separate control signaling. When the DRX operation or the DTX operation is performed, ON durations and SLEEP durations may be configured. The transmission and reception operation of the node may be performed in the ON duration. The transmission and reception operation of the node may not be performed in the SLEEP duration. Alternatively, the transmission and reception operation of the node may be performed restrictedly in the SLEEP duration. According to the discontinuous transmission and reception operations, the configuration of the integrated radio resources may be suspended, released, or terminated, and the configuration related parameters of the integrated radio resources may be reconfigured.

Meanwhile, the signaling procedure for the variable management of the integrated radio resources of FIG. 17 may be applied to the XL between the base station and the linking base station and the AL between the linking base station and the terminal belonging to the service area of the linking base station. In this case, the procedure for configuring or managing the integrated radio resources may be performed using the IAB signaling messages. For example, the linking base station may provide a communication service to the terminal belonging to the service area of the linking base station by using the AL within the range of the allowable resources according to the configuration of the integrated radio resources, and provide a communication service to the base station by using the XL within the range of the allowable resources according to the configuration of the integrated radio resources. Also, the base station may provide a communication service to the terminal belonging to the service area of the base station by using the AL within the range of the allowable resources according to the configuration of the integrated radio resources. Alternatively, the base station may provide a communication service to the terminal belonging to the service area of the base station by using resources different from the allowable resources according to the configuration of the integrated radio resources.

In the above-described embodiments, the procedure for configuring or managing the integrated radio resources, the procedure for configuring the allowable resources, and the triggering procedure for changing the integrated radio resources (e.g., allowable resources) may be applied without restriction as long as a reference condition for providing a communication service by using the same frequency band is satisfied.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a base station belonging to an access network in a communication system composed of the access network, an Xhaul network, and a core network, the operation method comprising:
performing a first connection establishment procedure with a linking node belonging to the Xhaul network;
performing a second connection establishment procedure with a management node supporting a mobility function and belonging to the core network when the first connection establishment procedure is completed;
configuring integrated radio resources used commonly in the access network and the Xhaul network when the second connection establishment procedure is completed; and
configuring a first allowable resource to be used for the access network within the integrated radio resources,
wherein the Xhaul network supports communications between the access network and the core network.

2. The operation method according to claim 1, wherein the integrated radio resources are a frequency band commonly used in the access network and the Xhaul network.

3. The operation method according to claim 1, wherein capability information of the base station is transmitted in the first connection establishment procedure and the second connection establishment procedure.

4. The operation method according to claim 1, wherein the configuring integrated radio resources is performed under a control of a node determined as a primary node among the base station, the linking node, and the management node.

5. The operation method according to claim 1, wherein the first allowable resource is configured to be orthogonal to a second allowable resource used for the Xhaul network.

6. The operation method according to claim 1, wherein the linking node is a base station or an Xhaul distributed unit (XDU) performing a relay function.

7. The operation method according to claim 1, further comprising transmitting a synchronization signal and system information by using the first allowable resource.

8. The operation method according to claim 1, further comprising:
performing a third connection establishment procedure with a terminal belonging to a service area of the base station; and
providing a communication service to the terminal using the first allowable resource when the third connection establishment procedure is completed.

9. The operation method according to claim 1, further comprising:
transmitting a triggering message requesting a change of the integrated radio resources when a predefined event occurs; and
reconfiguring the integrated radio resources based on the triggering message.

10. The operation method according to claim 9, wherein the predefined event includes at least one of a case when a change rate of the first allowable resource is equal to or greater than a threshold value, a case when an occupancy rate of the first allowable resource is equal to or greater than a threshold value, a case when a block error rate (BLER) is equal to or greater than a threshold value in communications based on the first allowable resource, a case when a latency time is equal to or larger than a threshold value in communications based on the first allowable resource, and a case when a transmission buffer residence time is equal to or greater than a threshold value in communications based on the first allowable resource.

11. The operation method according to claim 1, further comprising:
transmitting a release message requesting release of the integrated radio resources when a predefined event occurs; and
releasing the integrated radio resources based on the release message.

12. The operation method according to claim 11, wherein the predefined event includes at least one of a case when the base station terminates provision of a communication service based on the integrated radio resources, a case when an operation state of the base station transitions from an active state to an inactive state, and a case when a management function of the integrated radio resources in each of the base station, the linking node, and the management node is suspended.

13. A base station belonging to an access network in a communication system composed of the access network, an Xhaul network, and a core network, the base station comprising a processor and a memory storing at least one instruction executed by the processor, wherein the at least one instruction is configured to:
perform a first connection establishment procedure with a linking node belonging to the Xhaul network;
perform a second connection establishment procedure with a management node supporting a mobility function and belonging to the core network when the first connection establishment procedure is completed;
configure integrated radio resources used commonly in the access network and the Xhaul network when the second connection establishment procedure is completed; and
configure a first allowable resource to be used for the access network within the integrated radio resources,
wherein the Xhaul network supports communications between the access network and the core network.

14. The base station according to claim 13, wherein the integrated radio resources are a frequency band commonly used in the access network and the Xhaul network.

15. The base station according to claim 13, wherein the integrated radio resources are configured under a control of a node determined as a primary node among the base station, the linking node, and the management node.

16. The base station according to claim 13, wherein the at least one instruction is further configured to transmit a synchronization signal and system information by using the first allowable resource.

17. The base station according to claim 13, wherein the at least one instruction is further configured to perform a third connection establishment procedure with a terminal belonging to a service area of the base station; and provide a communication service to the terminal using the first allowable resource when the third connection establishment procedure is completed.

18. The base station according to claim 13, wherein the at least one instruction is further configured to transmit a triggering message requesting a change of the integrated radio resources when a predefined event occurs; and reconfigure the integrated radio resources based on the triggering message.

19. The base station according to claim 18, wherein the predefined event includes at least one of a case when a change rate of the first allowable resource is equal to or greater than a threshold value, a case when an occupancy rate of the first allowable resource is equal to or greater than a threshold value, a case when a block error rate (BLER) is equal to or greater than a threshold value in communications based on the first allowable resource, a case when a latency time is equal to or larger than a threshold value in communications based on the first allowable resource, and a case when a transmission buffer residence time is equal to or greater than a threshold value in communications based on the first allowable resource.

20. The base station according to claim 13, wherein the at least one instruction is further configured to transmit a release message requesting release of the integrated radio resources when a predefined event occurs; and release the integrated radio resources based on the release message.
